(19) United States
(12) Patent Application Publication
(10) Pub. No.: US 2026/0187738 A1
(43) Pub. Date: Jul. 2, 2026

(54) Energy exchange in a set of entities

(71) Applicant: ORANGE, Issy-les-Moulineaux (FR)

(72) Inventors: Fatma Ezzahra Salem, Chatillon (FR); Michel Giordani, Chatillon (FR)

(21) Appl. No.: 18/867,193

(22) PCT Filed: May 12, 2023
(86) PCT No.: PCT/EP2023/062725

§ 371 Date: Nov. 19, 2024

(30) Foreign Application Priority Data
May 20, 2022 (FR) FR2204871

(51) Int. Cl. G06Q 50/06; G06Q 40/04

(52) U.S. Cl. CPC G06Q 50/06; G06Q 40/0421

(57) ABSTRACT

A method for exchanging energy in a set of at least two entities which are configured, respectively, according to at least one energy use profile. The method implements in an entity: receiving information relating to a value of the price that energy available in a current time interval costs from the other entity and/or from an energy supplier, and relating to a value of the amount of energy which depends on, in the current time interval, the amount of energy produced by at least one energy-producing sub-entity, on the amount of energy consumed by at least one energy-consuming sub-entity, and on the amount of energy stored by at least one energy-storing sub-entity; and based on the value of the amount of energy and the price, selecting an action from among supplying energy and receiving energy to/from the other entity or the energy supplier, according to a performance criterion.

### FIELD OF THE INVENTION

The invention relates in general to the field of energy exchange on an energy marketplace, in which multiple entities that make up this marketplace are able to implement energy transactions on this marketplace, depending on their corresponding profile, which may be for example energy producer and/or energy consumer and/or energy store.

More specifically, the invention relates to the selection of an optimum energy exchange strategy for each entity, so that each entity in the marketplace implements an energy transaction, in other words requests and/or supplies energy while complying with at least one criterion such as reducing expenditure to request energy when the entity consumes energy, increasing profits when the entity produces energy, increasing/maintaining the comfort of the user of the entity when the entity consumes energy, reducing carbon footprint when the entity implements an energy transaction, etc.

### PRIOR ART

There are currently various possible models of energy marketplaces. However, the mechanisms put in place to optimize the exchange of energy may still be improved. Indeed, in some energy marketplace modeling works, calculations are taken up by a limited number of entities that make up the marketplace, while others are incomplete because they do not take into account the multi-profile nature that an entity may have (consume/produce/store) or because they address only one facet of the energy exchange strategy (for example managing the balance between energy demand and the response to this demand, controlling how energy needs are distributed at each entity, scheduling the operation of energy-consuming entities, etc.).

### AIM AND SUMMARY OF THE INVENTION

One of the aims of the invention is to rectify drawbacks of the abovementioned prior art by proposing an energy exchange method that makes it possible, for a given entity of the marketplace, to take into account all possible energy use profiles conferred on this entity, and all possible energy exchange strategies determined by this entity, for the benefit of an optimized distribution of the calculations over all of the entities of the marketplace, so as to optimize the performance of the energy exchange between the entities.

To this end, one subject of the present invention relates to a method for exchanging energy within a set of at least two entities that are configured, respectively, in accordance with at least one energy use profile from among a first energy production profile, a second energy consumption profile and a third energy storage profile.

Such a method is noteworthy in that it implements the following in a current time interval, at at least one of the entities:
receiving information relating to:
an amount of energy value that, according to the profile of said at least one entity, depends on:
   the amount of energy produced, in the current time interval, by at least one energy production sub-entity associated with said at least one entity,
   the amount of energy consumed, in the current time interval, by at least one energy consumption sub-entity associated with said at least one entity,
   the amount of energy stored, in the current time interval, by at least one energy storage sub-entity associated with said at least one entity,
a value of the cost price of the energy available in the current time interval from the other entity and/or from an energy supplier external to said set,
based on said amount of energy value and on the value of said price, selecting, where applicable, an action from among an action of supplying energy to said other entity or to the external energy supplier, an action of requesting energy from said other entity or from the external energy supplier, said selection being implemented in accordance with an energy exchange performance criterion.

The invention advantageously makes it possible to construct an energy marketplace between various entities of one and the same set that takes into account all possible energy use profiles of a given entity, namely producing energy and/or consuming energy and/or storing energy, thereby making it a particularly complete energy marketplace. Such a set of entities is for example a group of dwellings located in one and the same district, a set of buildings located in an industrial zone, a fleet of ships in a port, a plurality of base stations respectively serving a plurality of cells of a communication network, etc. The set of entities is not limited to an entity of one and the same type, for example a dwelling, a building, a ship, a base station, etc. The set of entities may thus comprise for example one or more dwellings in one and the same district and one or more base stations, one or more ships in a port and one or more base stations, etc.

Such an energy exchange method is not only efficient and precise, in terms of the action that is selected in the current time interval, but is also adaptable over time, because it is based on a hierarchical structure composed of higher-level entities that interact with lower-level sub-entities. Such interaction is advantageous in that it allows the higher-level entity, based on the information received from one or more sub-entities associated with this entity, to select the optimum energy use strategy in the current time interval, in accordance with an energy performance criterion.

According to one particular embodiment, the energy performance criterion that is used minimizes the cost of the energy requested by said at least one entity in the current time interval and maximizes the profit from supplying energy to the other entity or to the external energy supplier in the current time interval.

According to this embodiment, the optimum energy use strategy, in the current time interval, is advantageously based on a compromise between reducing expenditure for the energy requested by the entity and maximizing profits for the energy supplied by the entity.

According to another particular embodiment, the received information furthermore comprises a carbon footprint value determined, in the current time interval, by said at least one energy production or storage sub-entity associated with said at least one entity, and transmitted by said at least one sub-entity to said at least one entity, and wherein an action is furthermore selected based on said carbon footprint value in accordance with a criterion of minimizing the carbon footprint of the energy to be supplied to the other entity or to the external energy supplier.

This embodiment has the advantage of adding minimizing the carbon footprint of the energy to be supplied to the other entity to the compromise between reducing expenditure for the energy requested by the entity and maximizing profits for the energy supplied by the entity. The energy exchange method according to this embodiment is therefore made more energy-efficient and less polluting.

According to another particular embodiment, the amount of energy to be consumed, in the current time interval, by at least one energy consumption sub-entity associated with said at least one entity is based on the energy consumption calculated at at least one energy-consuming device that is associated with said at least one energy consumption sub-entity, in accordance with the minimization of a criterion regarding dissatisfaction of a user of said at least one device, said criterion being related:
either to a shift in the use of said at least one device to a time interval following the current time interval, if said at least one device has a time-shiftable use profile,
or to a decrease in the power level of said at least one device in the current time interval, if said at least one device has a power-shiftable use profile.

Such an embodiment allows the energy consumption sub-entity associated with said at least one entity to apply, at the level thereof, an optimum strategy to determine, in the current time interval, the amount of energy to be consumed in accordance with an energy performance criterion that is based, here, on minimizing the dissatisfaction of a user of at least one energy-consuming device attached to the energy consumption sub-entity as a sub-entity of this energy consumption sub-entity.

According to another particular embodiment, said at least one energy production sub-entity associated with said at least one entity implements the following in the current time interval:
receiving information relating to:
   a value of the cost price of the energy available in the current time interval from the other entity and/or from an energy supplier external to said set,
   the amount of energy stored, in the current time interval, by at least one energy storage sub-entity associated with said at least one entity, if said at least one storage sub-entity is present,
based on the value of the price and, where applicable, on the amount of energy stored, and in accordance with an energy production performance criterion:
   selecting a destination for the energy produced by said at least one energy production sub-entity in the current time interval from among said other entity or the external energy supplier, said at least one energy storage sub-entity associated with said at least one entity, at least one energy-consuming device associated with said at least one energy consumption sub-entity,
   calculating the amount of energy produced to be used according to the selected destination.

Such an embodiment allows the energy production sub-entity associated with said at least one entity to also apply, at the level thereof, an optimum strategy for determining, in the current time interval, the amount of energy to be used in accordance with an energy production performance criterion, depending on the action selected according to this criterion, which is that of either supplying energy to the other entity or to the external energy supplier, charging an energy storage sub-entity associated with said at least one entity, or supplying energy to at least one energy-consuming device attached to said at least one energy consumption entity.

According to another particular embodiment, said at least one energy storage sub-entity associated with said at least one entity implements the following in the current time interval:
receiving information relating to at least one value of the cost price of the energy available in the current time interval from an energy supplier external to said set,
based on the value of the price, on the amount of energy stored in the current time interval, by said at least one energy storage sub-entity, and according to a performance criterion regarding the use of the stored energy, selecting:
   an action relating to not recharging or recharging said at least one storage sub-entity with energy,
   an action relating to not discharging or discharging energy from said at least one storage sub-entity,
calculating the amount of energy required for recharging, respectively discharging, if the action relating to recharging, respectively discharging, is selected.

Such an embodiment allows the energy storage sub-entity associated with said at least one entity to also apply, at the level thereof, an optimum strategy to determine, in the current time interval, the amount of energy required to recharge or discharge it in accordance with a performance criterion regarding the use of the stored energy.

According to another particular embodiment, the performance criterion regarding the use of the stored energy maximizes the duration of the life cycle of said at least one storage sub-entity.

According to this embodiment, the performance criterion regarding the use of the stored energy that is used by the energy storage sub-entity advantageously takes into account the maximization of the duration of the life cycle of the storage sub-entity to determine the energy to be used for charging or discharging thereof. Said at least one energy storage sub-entity, also at the level thereof, thus selects its action with a view to saving energy and reducing pollution, thereby contributing to complying with the objectives of sustainable development.

According to another particular embodiment, the steps implemented by said at least one entity, said energy production, energy consumption and energy storage sub-entities and said at least one energy-consuming device are executed using a learning algorithm.

Such a learning algorithm is particularly well suited to the hierarchical structure on which the energy exchange method according to the invention is based, in which each action will be learned level by level, that is to say at the level of the entities of said set, at the level of the sub-entities associated with the entities of said set, and at the level of the one or more energy-consuming devices associated in particular with said at least one energy consumption sub-entity. The learning of the actions is thus advantageously distributed over each of these levels rather than being focused solely on the entities of said set, thereby making the energy exchange method according to the invention scalable and speeding up its learning.

According to another particular embodiment, the learning algorithm is a reinforcement learning algorithm, in which:
the entities are agents, while the sub-entities and said at least one energy-consuming device are sub-agents associated with the agents,
the information received by the agents and the sub-agents is representative of an environment in which the energy exchange method is implemented,
the selected actions are decisions made by the agents.

The benefit of using such a reinforcement learning algorithm is that it is particularly powerful and reliable in the case of an energy exchange method based on a plurality of agents and corresponding sub-agents, such as the energy exchange method according to the invention.

According to another particular embodiment, for at least one agent under consideration, the agent transmits at least one objective to at least one sub-agent associated therewith and in a given state, this objective having to be satisfied by the sub-agent and being integrated into the given state of the sub-agent.

Thus, in this particular embodiment, communication is advantageously established between at least one agent of the marketplace and a sub-agent associated therewith, thereby characterizing the hierarchical structure of the marketplace.

The various abovementioned embodiments or implementation features may be added, independently or in combination with one another, to the energy exchange method defined above.

The invention also relates to an entity configured to exchange energy with at least one other entity, said entity and said other entity belonging to a set of entities configured in accordance with at least one energy use profile from among a first energy production profile, a second energy consumption profile and a third energy storage profile.

Such an entity is noteworthy in that it implements the following, in a current time interval:
receiving information relating to:
an amount of energy value that, according to the profile of said at least one entity, depends on:
   the amount of energy produced, in the current time interval, by at least one energy production sub-entity associated with said at least one entity,
   the amount of energy consumed, in the current time interval, by at least one energy consumption sub-entity associated with said at least one entity,
   the amount of energy stored, in the current time interval, by at least one energy storage sub-entity associated with said at least one entity,
a value of the cost price of the energy available in the current time interval from the other entity and/or from an energy supplier external to said set,
based on the amount of energy value and on the value of said price, selecting, where applicable, an action from among an action of supplying energy to said other entity or to the external energy supplier, an action of requesting energy from said other entity or from the external energy supplier, said selection being implemented in accordance with an energy exchange performance criterion.

Such an entity is in particular able to implement the abovementioned energy exchange method.

The invention also relates to a computer program comprising instructions for implementing the energy exchange method according to the invention, according to any one of the particular embodiments described above, when said program is executed by a processor.

Such instructions may be stored durably in a non-transient memory medium of an entity or sub-entity implementing the energy exchange method according to the invention.

This program may use any programming language, and be in the form of source code, object code, or intermediate code between source code and object code, such as in a partially compiled form, or in any other desirable form.

The invention also targets a computer-readable recording medium or information medium comprising instructions of a computer program as mentioned above.

The recording medium may be any entity or device capable of storing the program. For example, the medium may comprise a storage means, such as a ROM (read-only memory), for example a CD-ROM (compact disc read-only memory) or a microelectronic circuit ROM, or else a magnetic recording means, for example a mobile medium, a hard drive or an SSD (solid-state drive).

Furthermore, the recording medium may be a transmissible medium such as an electrical or optical signal, which may be routed via an electrical or optical cable, by radio or by other means, such that the computer program that it contains is able to be executed remotely. The program according to the invention may in particular be downloaded from a network, for example an Internet network.

As an alternative, the recording medium may be an integrated circuit in which the program is incorporated, the circuit being designed to execute or to be used in the execution of the abovementioned energy exchange method.

According to one exemplary embodiment, the present technique is implemented by way of software components and/or hardware components. With this in mind, the term “module” may correspond in this document equally to a software component, to a hardware component or to a set of software components and hardware components.

### BRIEF DESCRIPTION OF THE DRAWINGS

Other features and advantages will become apparent on reading particular embodiments of the invention, which are given by way of illustrative and non-limiting example, and the appended drawings, in which:

FIG. 1 shows one example of an architecture in which the energy exchange method according to the invention is implemented, according to one particular embodiment,

FIG. 2 shows the structure of a set of entities implementing the energy exchange method, in one particular embodiment of the invention,

FIG. 3 shows one example of an architecture of an entity implementing the energy exchange method, according to a first particular embodiment of the invention,

FIG. 4 shows the main steps implemented by an entity of the set of entities, in the energy exchange method according to the invention, according to a first particular embodiment of the invention,

FIG. 5 shows the main actions implemented by an energy production sub-entity of the set of entities, when implementing the energy exchange method, according to a first particular embodiment of the invention,

FIG. 6 shows the main actions implemented by an energy storage sub-entity of the set of entities, when implementing the energy exchange method, according to a first particular embodiment of the invention,

FIG. 7 shows the main actions implemented by an electric vehicle sub-entity of the set of entities, when implementing the energy exchange method, according to a first particular embodiment of the invention,

FIG. 8 shows the main actions implemented by an energy consumption sub-entity of the set of entities when implementing the energy exchange method, according to a first particular embodiment of the invention,

FIG. 9A shows the main actions implemented by an energy-consuming device associated with the energy consumption sub-entity of the set of entities when implementing the energy exchange method, according to a first particular embodiment of the invention, the operation of the energy-consuming device being time-shiftable,

FIG. 9B shows the main actions implemented by an energy-consuming device associated with the energy consumption sub-entity of the set of entities when implementing the energy exchange method, according to a first particular embodiment of the invention, the power level of the energy-consuming device being time-variable,

FIG. 10 shows one example of an architecture of an entity or sub-entity implementing the energy exchange method, according to a second particular embodiment of the invention,

FIG. 11 shows the main steps implemented by an entity of the set of entities, in the energy exchange method according to the invention, according to a second particular embodiment of the invention,

FIG. 12 shows the main actions implemented by an energy production sub-entity of the set of entities, when implementing the energy exchange method, according to a second particular embodiment of the invention,

FIG. 13 shows the main actions implemented by an energy storage sub-entity of the set of entities, when implementing the energy exchange method, according to a second particular embodiment of the invention,

FIG. 14 shows the main actions implemented by an electric vehicle sub-entity of the set of entities, when implementing the energy exchange method, according to a second particular embodiment of the invention,

FIG. 15 shows the main actions implemented by an energy-consuming device associated with the energy consumption sub-entity of the set of entities when implementing the energy exchange method, according to a second particular embodiment of the invention, the operation of the energy-consuming device being time-shiftable,

FIG. 16 shows the main actions implemented by an energy-consuming device associated with the energy consumption sub-entity of the set of entities when implementing the energy exchange method, according to a second particular embodiment of the invention, the power level of the energy-consuming device being time-variable.

### DETAILED DESCRIPTION OF EMBODIMENTS OF THE INVENTION

With reference to FIG. 1, a description is given of one example of an architecture in which the energy exchange method according to the invention is implemented. According to this architecture, an energy exchange system or energy marketplace Xplace comprises:
a set E of at least two entities ENT₁ and ENT₂ configured to exchange energy with one another, these at least two entities being located at a first upper hierarchical level L1 in the set E,
possibly one or more energy suppliers FE, external to said set of entities E, which is/are configured to exchange energy with the entity ENT₁ and/or the entity ENT₂.

In this energy marketplace, if an entity produces renewable energy, the climatic conditions CC are also taken into account, and are conditions external to the set E.

The energy that is exchanged may be of various types: electricity, gas, fuel, heat, etc.

According to the invention:
at least one sub-entity S_ENT₁ is attached to the entity ENT₁ at a second hierarchical level L2 below the level L1,
at least one sub-entity S_ENT₂ is attached to the entity ENT₂ at the second hierarchical level L2.

According to the invention:
at least one sub-entity SS_ENT₁ may be attached to the sub-entity S_ENT₁ at a third hierarchical level L3 below the level L2,
at least one sub-entity SS_ENT₂ may be attached to the sub-entity S_ENT₂ at the third hierarchical level L3.

The third level L3 is optional. For this reason, the sub-entities SS_ENT₁ and SS_ENT₂ are shown in dashed lines in FIG. 1.

As an alternative, the sub-entities SS_ENT₁ and SS_ENT₂ could be located on the second hierarchical level L2.

Each of the entities ENT₁ and ENT₂ is advantageously configured in accordance with at least one energy use profile from among a first energy production profile PF1, a second energy consumption profile PF2 and a third energy storage profile PF3 or any possible combination of these profiles.

An entity according to the invention implements an energy transaction in the system or the energy marketplace from FIG. 1. To this end, an entity may be a commercial building (a factory for example) or a residential building (a dwelling for example). An entity may also be a ship or a base station in a communication network. The set E may contain entities of the same nature, such as for example a suburban district consisting of “dwelling” entities, a fishing port consisting of “ship” entities or a communication network consisting of “base station” entities. As an alternative, the set E may contain entities of a different nature. Thus, for example, the set E could be a port district of a city that might simultaneously contain “house”, “dwelling”, “ship” and/or “base station” entities.

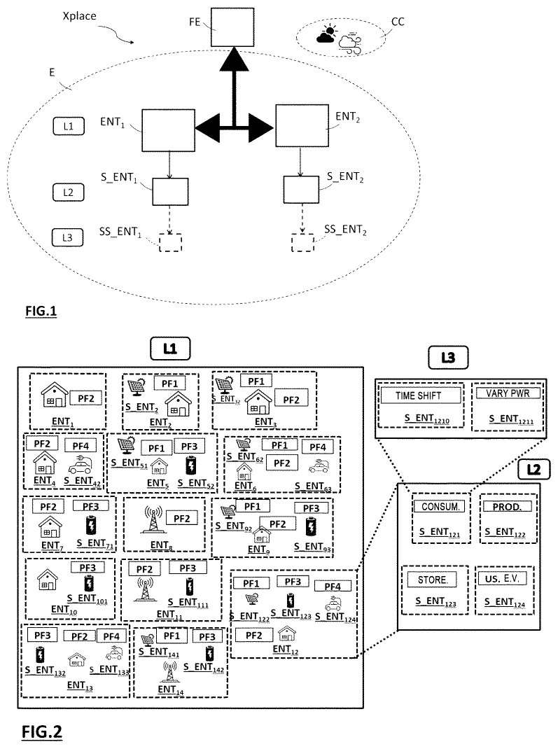

One embodiment of the set E is shown in FIG. 2, solely by way of illustration, in which “house” and “base station” entities are present, at an upper hierarchical level L1. In the example shown, fourteen entities ENT₁ to ENT₁₄ are shown, among which:
the entities ENT₁ to ENT₇, ENT₉, ENT₁₀, ENT₁₂ and ENT₁₃ are houses or buildings,
the entities ENT₈, ENT₁₁ and ENT₁₄ are base stations.

Of course, this number of entities may be less than or more than 14, depending on the context of the energy transaction to be implemented.

Each of the entities shown is associated with one or more energy use profiles. Depending on the envisaged use profile, one or more sub-entities are attached to an entity under consideration, at a hierarchical level L2 or L3 below the hierarchical level L1.

In the example shown in FIG. 2:
the entity ENT₁ has an energy consumption profile PF2: it is thus associated with at least one sub-entity S_ENT₁ (not shown) that consumes energy, such as for example a refrigerator, one or more radiators, a washing machine, a condensate pump, etc.;
the entity ENT₂ has an energy production profile PF1: it is thus associated with at least one sub-entity S_ENT₂ that produces energy, for example a photovoltaic panel;
the entity ENT₃ has the two profiles PF1 and PF2: it is thus associated with at least one sub-entity S_ENT₃₁ (not shown) that consumes energy, of the abovementioned type, and with at least one sub-entity S_ENT₃₂ that produces energy, for example a photovoltaic panel;
the entity ENT₄ has the profile PF2 and a use profile PF4 of an electric vehicle, that is to say both an energy storage profile and an energy consumption profile: it is thus associated with at least one sub-entity S_ENT₄₁ (not shown) that consumes energy, of the abovementioned type, and with a sub-entity S_ENT₄₂, which is the electric vehicle;
the entity ENT₅ has the profile PF1 and an energy storage profile PF3: it is thus associated with at least one sub-entity S_ENT₅₁ that produces energy, for example a photovoltaic panel, and with at least one sub-entity S_ENT₅₂ that stores energy, for example a battery;
the entity ENT₆ has the three profiles PF1, PF2 and PF4: it is thus associated with at least one sub-entity S_ENT₆₁ (not shown) that consumes energy, of the abovementioned type, and with at least one sub-entity S_ENT₆₂ that produces energy, for example a photovoltaic panel, and with a sub-entity S_ENT₆₃, which is an electric vehicle;
the entity ENT₇ has an energy consumption profile PF2: it is thus associated with at least one sub-entity S_ENT₇₁ (not shown) that consumes energy, of the abovementioned type, and with at least one sub-entity S_ENT₇₂ that stores energy, for example a battery;
the entity ENT₈ has an energy consumption profile PF2 when the base station both transmits or receives a signal: it is thus associated with at least one sub-entity S_ENT₈₁ (not shown) that consumes energy;
the entity ENT₉ has the three profiles PF1, PF2 and PF3: it is thus associated with at least one sub-entity S_ENT₉₁ (not shown) that consumes energy, of the abovementioned type, and with at least one sub-entity S_ENT₉₂ that produces energy, for example a photovoltaic panel, and with a sub-entity S_ENT₉₃ that stores energy, for example a battery;
the entity ENT₁₀ has the profile PF3 and is therefore associated with a sub-entity S_ENT₁₀₁ that stores energy, for example a battery;
the entity ENT₁₁ has the profiles PF2 and PF3: it is thus associated with at least one sub-entity S_ENT₁₁₁ (not shown) that consumes energy, of the abovementioned type, and with at least one sub-entity S_ENT₁₁₂ that stores energy, for example a battery;
the entity ENT₁₂ has the four profiles PF1 to PF4: it is thus associated with at least one sub-entity S_ENT₁₂₁ (not shown) that consumes energy, and with at least one sub-entity S_ENT₁₂₂ that produces energy, for example a photovoltaic panel, with a sub-entity S_ENT₁₂₃ that stores energy, for example a battery, and with a sub-entity S_ENT₁₂₄, which is an electric vehicle;
the entity ENT₁₃ has the three profiles PF2, PF3, PF4: it is thus associated with at least one sub-entity S_ENT₁₃₁ (not shown) that consumes energy, of the abovementioned type, and with at least one sub-entity S_ENT₁₃₂ that stores energy, for example a battery, and with a sub-entity S_ENT₁₃₃, which is an electric vehicle;
the entity ENT₁₄ has the two profiles PF1 and PF3: it is thus associated with at least one sub-entity S_ENT₁₄₁ that produces energy, for example a photovoltaic panel, and with at least one sub-entity S_ENT₁₄₂ that stores energy, for example a battery.

Of course, other configurations are possible and depend on the context of the energy transaction to be implemented. In addition, in other examples:
an energy production sub-entity could be a wind turbine, a methanization device, etc.,
an energy storage sub-entity could be an inertial storage device, a compressed-air storage device, a methanation device, etc.,
an electric vehicle may comprise an electric car and/or an electric boat and/or an electric scooter, etc.

According to the invention, the set E is broken down such that each of the sub-entities described above is located at a hierarchical level L2 that is below the level L1. For the sake of clarity in FIG. 2, such a breakdown is shown only for the entity ENT₁₂ for which the sub-entities S_ENT₁₂₁ to S_ENT₁₂₄ are attached to the entity ENT₁₂ at the lower hierarchical level L2.

In the example shown, an optional third hierarchical level L3 is shown. The level L3 comprises:
at least one sub-entity SS_ENT₁₂₁₀ attached to the sub-entity S_ENT₁₂₁ and comprising at least one device the use of which is time-shiftable, for example an electric radiator, a washing machine, etc., and/or
at least one sub-entity SS_ENT₁₂₁₁ attached to the sub-entity S_ENT₁₂₁ and comprising at least one device the operating power level of which is variable, for example a lighting device, a transmitter of a base station, etc.

According to the invention, the energy transaction is implemented at the upper hierarchical level L1 by at least two entities ENT₁ and ENT₂ that form said level. During this transaction, when one of the at least two entities, for example ENT₁, exchanges energy with the other entity ENT₂ or an energy supplier FE, this action is carried out in accordance with an energy exchange performance criterion.

According to a first embodiment, such a criterion is a compromise between:
reducing energy expenditure related to the purchase of energy from the entity ENT₂ or from the energy supplier FE, and
maximizing revenue related to the sale of energy to the entity ENT₂ or to the energy supplier FE.

According to a second embodiment, such a criterion is a compromise between:
reducing energy expenditure related to the purchase of energy from the entity ENT₂ or from the energy supplier FE,
maximizing revenue related to the sale of energy to the entity ENT₂ or to the energy supplier FE, and
minimizing the carbon footprint related to the energy transaction.

According to the invention, at the middle hierarchical level L2, the energy distribution is implemented at each of the sub-entities attached to the entity ENT₁, respectively ENT₂, such an energy distribution being controlled by the entity ENT₁, respectively ENT₂. To this end,
if for example the entity ENT₁ has an energy consumption profile PF2, a decision is made by the entity ENT₁ as to whether it is better, according to an energy exchange performance criterion, to consume energy from one or more storage sub-entities attached to the entity ENT₁, if present, and/or from one or more “electric vehicle” sub-entities attached to the entity ENT₁, if present, and/or
if for example the entity ENT₁ has an energy production profile PF1, a decision is made by the entity ENT₁ as to whether it is better, according to an energy exchange performance criterion, to produce energy using the energy production sub-entity (photovoltaic panel, wind turbine, etc.) attached to the entity ENT₁, and/or
whether it is better, according to an energy exchange performance criterion, to request (purchase) energy from an external energy supplier or from another entity of the set E of entities, for example ENT₂, to supply the one or more energy consumption sub-entities attached to the entity ENT₁, if present, and/or store this purchased energy in the one or more storage sub-entities attached to the entity ENT₁, if present, and/or charge the one or more “electric vehicle” sub-entities attached to the entity ENT₁, if present.

According to the invention, at the lower hierarchical level L3, the use of energy is controlled by one or more energy consumption sub-entities, for example the sub-entity S_ENT₁₂₁, at each of the sub-entities attached to the sub-entity S_ENT₁₂₁, such as the sub-entities SS_ENT₁₂₁₀ and SS_ENT₁₂₁₁. To this end, it is at this level where any energy consumption sub-entity controls the “demand-response” functionality, which makes it possible to make decisions on how and/or when to use the one and/or more sub-entities (devices that consume energy) according to their type, namely the use of which is time-shiftable and the operating power level of which is variable.

According to the invention, such control is implemented by the energy consumption sub-entity while complying with a performance criterion regarding the use of the consumed energy that expresses for example the minimization of the dissatisfaction of the user of the energy-consuming devices that are present.

As already explained above, the hierarchical level L3 is optional, the use of energy being able to be controlled at the energy consumption sub-entity located at the hierarchical level L2, which then integrates the sub-entities SS_ENT₁₂₁₀ and SS_ENT₁₂₁₁.

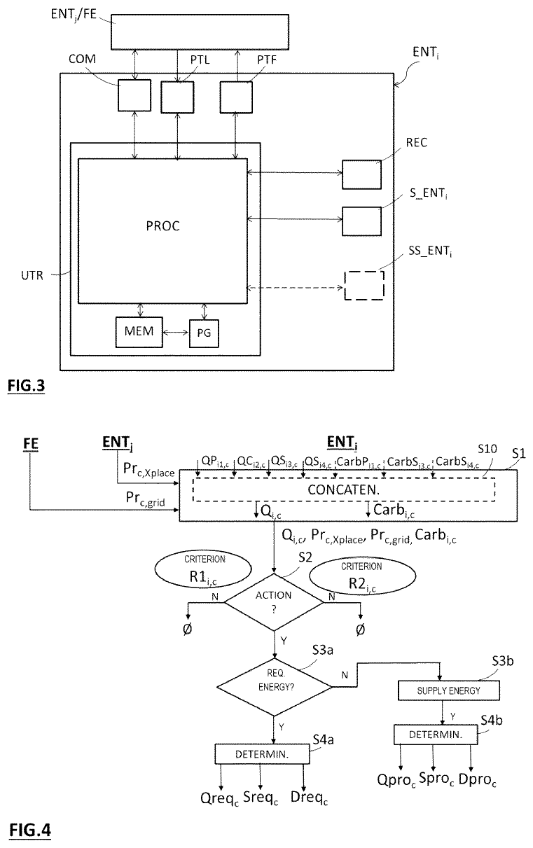

Description of a first embodiment of an entity able to exchange energy FIG. 3 shows the simplified structure of an entity ENTᵢ chosen from among the plurality of entities ENT₁ to ENT_{Ne} from FIG. 2, such that 1≤i≤Ne, where Ne represents the number of entities in the marketplace. In the example shown in FIG. 2, Ne=14.

Such an entity ENTᵢ is configured to implement the energy exchange method that will be described below.

The entity ENTᵢ comprises, according to the invention:
a communication module COM designed to communicate with at least one other entity ENTⱼ of the set E of entities, such that 1≤j≤Ne, or with at least one energy supplier FE, via a data communication network (not shown), which may be a short-range or medium-range wireless network, such as for example a Bluetooth, NFC, LTE, Wi-Fi, DSRC, C-V2X, etc. network, a long-range wireless network, such as for example a 2G, 3G, 4G, 5G, etc. network, a wired network such as an ADSL, fiber, etc. network, the subject of the communication possibly being a request for energy from the entity ENTⱼ or from the energy supplier FE or a proposal to supply energy to the entity ENTⱼ or to the energy supplier FE,
an energy delivery point (meter, wiring) PTL for receiving the energy supplied by the entity ENTⱼ or the energy supplier FE, via an energy distribution network, not shown in FIG. 3, and/or
an energy supply point (meter, wiring) PTF for supplying energy to the entity ENTⱼ or to the energy supplier FE via the abovementioned energy distribution network,
at least one energy consumption, energy production, energy storage sub-entity S_ENTᵢ, at least one electric vehicle,
possibly at least one sub-entity SS_ENTᵢ such as for example a device the use of which is time-shiftable, a device the operating power level of which is variable, a device the use of which is not time-shiftable and the operating power level of which is fixed,
a reception module REC for receiving information relating to the energy context in a current time interval.

Because the sub-entity SS_ENTᵢ is optional, it is shown in dashed lines in FIG. 3.

According to one particular embodiment of the invention, the actions carried out by the entity ENTᵢ, in the context of implementing the energy exchange method according to the present invention, are implemented by instructions of a computer program PG. For this purpose, the entity ENTᵢ comprises a conventional architecture of a computer and comprises in particular a memory MEM, a processing unit UTR, equipped for example with a processor PROC, and controlled by the computer program PG stored in memory MEM. The computer program PG comprises instructions for implementing the actions carried out by the entity ENTᵢ when the program is executed by the processor PROC, according to any one of the particular embodiments of the invention. On initialization, the code instructions of the computer program PG are for example loaded into a RAM memory (not shown) before being executed by the processor PROC. The processor PROC of the processing unit UTR implements in particular the communication actions via the module COM, the information reception actions via the module REC, the energy supply actions via the energy supply point PTF, and energy request actions via the energy delivery point PTL.

### Description of a First Embodiment of an Energy Exchange Method

A description will now be given, with reference to FIG. 4, of the sequence of an energy exchange method carried out by the entity ENTᵢ as illustrated in FIG. 3.

Such an energy exchange method takes place as follows at the entity ENTᵢ, in a current time interval IT_{c}.

In S1, the entity ENTᵢ receives, via the reception module REC from FIG. 3:
from at least one energy production sub-entity S_ENTᵢ (wind turbine, photovoltaic panel, etc.) associated with said at least one entity, if such a sub-entity is present, the amount QP_{i1,c} of energy produced in said current time interval by said at least one sub-entity S_ENTᵢ₁,
from at least one energy consumption sub-entity S_ENTᵢ₂ (radiator, washing machine, condensate pump, etc.) associated with said at least one entity, if such a sub-entity is present, the amount QC_{i2,c} of energy consumed in said current time interval by said at least one sub-entity S_ENTᵢ₂,
from at least one energy storage sub-entity S_ENTᵢ₃ (battery for example) associated with said at least one entity, if such a sub-entity is present, the amount QS_{i3,c} of energy stored in said current time interval by said at least one sub-entity S_ENTᵢ₃,
from at least one electric vehicle sub-entity S_ENTᵢ₄ associated with said at least one entity, if such a sub-entity is present, the amount QS_{i4,c} of energy stored in said current time interval by said at least one sub-entity S_ENTᵢ₄. During step S1, this information is concatenated in S10 if necessary, so as to obtain a value Q_{i,c} of the amount of energy required by the entity ENTᵢ in the current time interval, with Q_{i,c}=QP_{i1,c}+QS_{i3,c}+QS_{i4,c}−QC_{i2,c} (1).

According to one preferred embodiment, the entity ENTᵢ also receives, in S1, via the reception module REC from FIG. 3:
from said at least one energy production sub-entity S_ENTᵢ₁ (wind turbine, photovoltaic panel, etc.) associated with said at least one entity, if such a sub-entity is present, a value of the carbon footprint CarbP_{i1,c} that is related to the amount QP_{i1,c} of energy to be produced in said current time interval by said at least one sub-entity S_ENTᵢ₁,
from said at least one energy storage sub-entity S_ENTᵢ₃ (battery for example) associated with said at least one entity, if such a sub-entity is present, a value of the carbon footprint CarbS_{i3,c} that is related to the amount QS_{i3,c} of energy to be stored in said current time interval by said at least one sub-entity S_ENTᵢ₃,
from said at least one electric vehicle sub-entity S_ENTᵢ₄ associated with said at least one entity, if such a sub-entity is present, a value of the carbon footprint CarbS_{i4,c} that is related to the amount QS_{i4,c} of energy to be stored in said current time interval by said at least one sub-entity S_ENTᵢ₄.

During step S1, the values CarbP_{i1,c}, CarbS_{i3,c}, CarbS_{i4,c} are concatenated in S10 if necessary, so as to obtain a carbon footprint value Carb_{i,c}, such that

$${Carb}_{i , c} = {CarbP}_{i 1 , c} + {CarbS}_{i 3 , c} + {CarbS}_{i 4 , c} . \qquad ( 2 )$$

According to the invention, the carbon footprint value CarbP_{i1,c} is not taken into account in the rest of the sequence of the energy exchange method, given that it is close to 0 because it is related to the production of clean, non-polluting energy.

In S1, the entity ENTᵢ also receives, via the reception module REC from FIG. 3:
from at least one other entity ENTⱼ, a value of the cost price Pr_{c,Xplace} of the energy available in said current time interval from the other entity ENTⱼ,
from at least one energy supplier FE, if available, a value of the cost price Pr_{c,grid} of the energy available in said current time interval from the energy supplier FE.

The price Pr_{c,grid} of the supplier FE is a fixed price that generally varies according to the season or the period of the day (peak times, off-peak times).

According to the invention, the price Pr_{c,Xplace} is fixed prior to the energy exchange method being implemented. It is a fixed price that is determined for example as being lower than that of the supplier FE. The price Pr_{c,Xplace} may for example be fixed as being equal to a fraction or to a percentage of the price Pr_{c,grid} of the supplier. According to a more elaborate strategy, the price Pr_{c,Xplace} is based on auction theory.

In S2, based on the values Q_{i,c}, Pr_{c,Xplace}, Pr_{c,grid} and Carb_{i,c}, a type of energy transaction to be implemented in the current time interval is then selected.

Said selection may also be implemented by combining the values Q_{i,c}, Pr_{c,Xplace}, Pr_{c,grid} and Carb_{i,c} respectively with values of the same type that are obtained by learning in previous time intervals, for example using a supervised learning algorithm.

The selection S2 is implemented in accordance with a first performance criterion R1_{i,c} regarding the energy exchange in the current time interval.

In one exemplary embodiment, the criterion R1_{i,c} minimizes the price of the energy requested by the entity ENTᵢ in said current time interval and maximizes the profit from the supply of energy by the entity ENTᵢ to the other entity ENTⱼ or to the external energy supplier FE in said current time interval.

According to one example, the criterion R1_{i,c} is expressed in the form R1_{i,c}=−Pr_{c,grid}·Q_{i,a,c} (3) when the selected energy transaction is for example the purchase of energy from the external energy supplier FE or in the form R1_{i,c}=Pr_{c,Xplace}·Q_{i,v,c} (4) when the selected energy transaction is for example the sale of energy to the other entity ENTⱼ or to the external energy supplier FE, with Q_{i,a,c} and Q_{i,v,c} respectively representing the amounts of energy purchased and sold.

In the preferred embodiment, such a selection is implemented in accordance with a second performance criterion R2_{i,c} regarding the energy exchange in the current time interval.

In one exemplary embodiment, the criterion R2_{i,c}:
minimizes the price of the energy requested by the entity ENTᵢ in said current time interval,
maximizes the profit from the supply of energy by the entity ENTᵢ to the other entity ENTⱼ or to the external energy supplier FE in said current time interval,
minimizes the carbon footprint Carb_{i,c}.

The criterion R2_{i,c} is expressed in the form R2_{i,c}=−α_{c}·Pr_{c,grid}·Q_{i,a,c}−β_{c}·Carb_{i,c} (5) when the selected energy transaction is the purchase of energy from the external energy supplier FE, where α_{c} and β_{c} represent weighting coefficients between the cost Pr_{c,grid} of the energy and the carbon footprint Carb_{i,c}. The value of these weighting coefficients is adjusted by the user, for example via a user interface, and represents preferences of this user.

The criterion R2_{i,c} is expressed in the form R2_{i,c}=α′_{c}·Pr_{c,Xplace}·Q_{i,v,c}−β_{c}·Carb_{i,c} (6) when the selected energy transaction is the sale of energy to the other entity ENTⱼ or to the external energy supplier FE, where α′_{c} and β_{c} represent weighting coefficients between the profit related to the sale of energy and the carbon footprint Carb_{i,c}. The value of these weighting coefficients is adjusted by the user, for example via a user interface, and represents preferences of this user.

At the end of said selection S2, the entity ENTᵢ decides:
not to implement any particular action in the following time interval,
to implement, in the following time interval, a “purchase energy” transaction in S3a, that is to say request energy from the other entity ENTⱼ at the price Pr_{c,Xplace} and/or from the energy supplier FE at the price Pr_{c,grid},
to implement, in the following time interval, a “sell energy” transaction in S3b, that is to say supply energy to the other entity ENTⱼ and/or to the energy supplier FE at the price Pr_{c,Xplace} or another previously defined price.

If the “purchase energy” transaction is implemented in S3a, the entity ENTᵢ determines, in S4a, the amount of energy Qreq_{c} to be requested in the current time interval, the energy source Sreq_{c} (supplier FE or other entity ENTⱼ) from which to request the amount of energy Qreq_{c}, and the destination Dreq_{c} for the amount of energy Qreq_{c}, that is to say the energy storage sub-entity S_ENTᵢ₃, possibly one or more sub-entities associated with the sub-entity S_ENTᵢ₂, such as for example a device the use of which is time-shiftable, a device the operating power level of which is variable, a device the use of which is not time-shiftable and the operating power level of which is fixed, and the electric vehicle sub-entity S_ENTᵢ₄.

If the “sell energy” transaction is implemented in S3b, the entity ENTᵢ determines, in S4b, the amount of energy Qpro_{c} to be supplied in the current time interval, the energy source Spro_{c} (S_ENTᵢ₁, S_ENTᵢ₃, S_ENTᵢ₄) from which the amount of energy Qpro_{c} originates, and possibly the destination Dpro_{c} for the amount of energy Qpro_{c} to be produced, the entity ENTⱼ or the supplier FE in the example shown.

By virtue of the energy exchange method that has just been described above, the invention advantageously makes it possible to propose a more stable energy marketplace that is less vulnerable to failures and is more energy-efficient.

A description will now be given, with reference to FIG. 5, of the various steps carried out at said at least one energy production sub-entity S_ENTᵢ₁ (wind turbine, photovoltaic panel, etc.) that is associated with said at least one entity ENTᵢ, when the energy exchange method is implemented in the current time interval IT_{c} and when such a sub-entity is present.

In S1ᵢ₁, the sub-entity S_ENTᵢ₁ receives, via a reception module identical or similar to the one from FIG. 3:
from said at least one energy storage sub-entity S_ENTᵢ₃ (battery for example) associated with said at least one entity ENTᵢ, if such a sub-entity S_ENTᵢ₃ is present, the amount of energy QS_{i3,c} stored by the sub-entity S_ENTᵢ₃ in said current time interval,
from said at least one electric vehicle sub-entity S_ENTᵢ₄ associated with said at least one entity ENTᵢ, if such a sub-entity S_ENTᵢ₄ is present, the amount of energy QS_{i4,c} stored by the sub-entity S_ENTᵢ₄ in said current time interval,
from the entity ENTᵢ, the value of the cost price Pr_{c,Xplace} of the energy available in said current time interval from the other entity ENTⱼ and possibly the value of the cost price Pr_{c,grid} of the energy available in said current time interval from the energy supplier FE.

In S2ᵢ₁, based on the values QP_{i1,c}, QC_{i2,c}, QS_{i3,c}, QS_{i4,c}, Pr_{c,Xplace} and possibly Pr_{c,grid}, a type of action to be implemented in the current time interval by the energy production sub-entity S_ENTᵢ₁ is then selected.

Said selection may also be implemented by combining the values QP_{i1,c}, QC_{i2,c}, QS_{i3,c}, QS_{i4,c}, Pr_{c,Xplace} and possibly Pr_{c,grid} respectively with values of the same type that are obtained by learning in previous time intervals, for example using a supervised learning algorithm.

Such a selection S21 is implemented in accordance with a performance criterion R_{i1,c} regarding the use of the energy produced in the current time interval.

In one exemplary embodiment, the criterion R_{i1,c} maximizes the profit from the supply of the energy produced to the other entity ENTⱼ or to the external energy supplier FE in said current time interval, if the amount of energy produced by the sub-entity S_ENTᵢ₁ in the current time interval is sold to the other entity ENTⱼ or to the external energy supplier FE.

The criterion R_{i1,c} is expressed for example in the form R_{i1,c}=Pr_{c,Xplace}·QP_{i1,v,c}·(7), where QP_{i1,v,c} represents the amount of produced energy that is sold.

At the end of said selection S2ᵢ₁, the energy production sub-entity S_ENTᵢ₁ decides:
in S3aᵢ₁, to select the other entity ENTⱼ and/or the energy supplier FE as the recipient of all or some of the energy produced,
in S3bᵢ₁, to recharge the storage sub-entity S_ENTᵢ₃ with all or some of the energy produced,
in S3cᵢ₁, to recharge the sub-entity S_ENTᵢ₄ with all or some of the energy produced,
in S3dᵢ₁, to supply one or more sub-entities associated with the energy consumption sub-entity S_ENTᵢ₂, such as for example a device the use of which is time-shiftable, a device the operating power level of which is variable, a device the use of which is not time-shiftable and the operating power level of which is fixed.

If the decision S3aᵢ₁ is implemented, the energy production sub-entity S_ENTᵢ₁ calculates, in S4aᵢ₁, the amount QP_{i1,c} of energy produced with a view to the sale of this amount of energy by the entity ENTᵢ, in the following time interval IT_{c+1}, to the other entity ENTⱼ or to the external energy supplier FE.

If the decision S3bi is implemented, the energy production sub-entity S_ENTᵢ₁ calculates, in S4bᵢ₁, the amount QP_{i1,c} of energy produced to be used to recharge the energy storage sub-entity S_ENTᵢ₃ in the following time interval.

If the decision S3cᵢ₁ is implemented, the energy production sub-entity S_ENTᵢ₁ calculates, in S4cᵢ₁, the amount QP_{i1,c} of energy produced to be used to recharge the electric vehicle sub-entity S_ENTᵢ₄ in the following time interval.

If the decision S3dᵢ₁ is implemented, the energy production sub-entity S_ENTᵢ₁ calculates, in S4dᵢ₁, the amount QP_{i1,c} of energy produced to be used to supply, in the following time interval, at least one sub-entity SS_ENTᵢ₂₁ associated with the energy consumption sub-entity S_ENTᵢ₂, such as for example a device the use of which is time-shiftable, a device the operating power level of which is variable, a device the use of which is not time-shiftable and the operating power level of which is fixed.

In S5ᵢ₁, the calculated amount QP_{i1,c} of energy produced, associated with the selected action, is then transmitted to the entity ENTᵢ, in the following time interval.

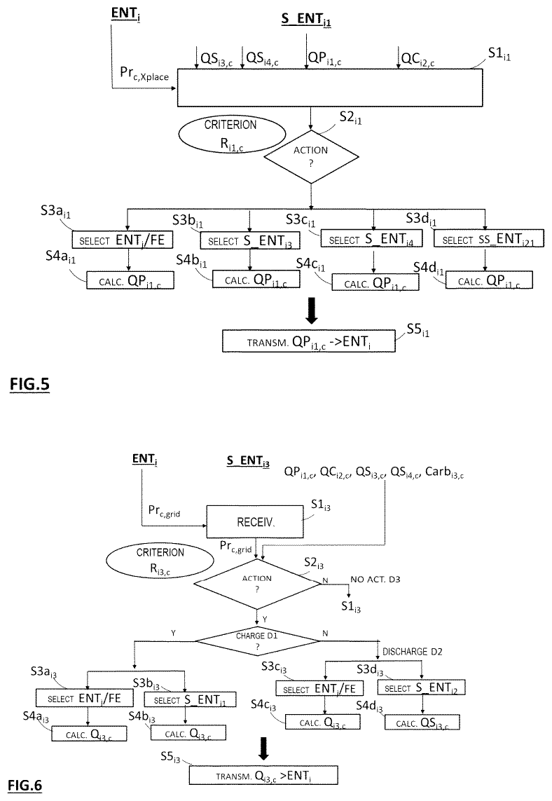

A description will now be given, with reference to FIG. 6, of the various steps carried out at said at least one energy storage sub-entity S_ENTᵢ₃ (battery, rechargeable battery etc.) that is associated with said at least one entity ENTᵢ, when the energy exchange method is implemented in the current time interval IT_{c} and when such a sub-entity is present.

In S1ᵢ₃, the sub-entity S_ENTᵢ₃ receives, from the entity ENTᵢ, via a reception module identical or similar to the one from FIG. 3, the value of the cost price Pr_{c,grid} of the energy available in said current time interval from the energy supplier FE, possibly the value of the price Pr_{c,Xplace}.

In S2ᵢ₃, based on the value of Pr_{c,grid} and/or Pr_{c,Xplace}, on the value of the amount of energy QP_{i1,c} produced by the sub-entity S_ENTᵢ₁, on the value of the amount of energy QC_{i2,c} consumed by the sub-entity S_ENTᵢ₂, on the value of the amount of energy QS_{i3,c} stored by the sub-entity S_ENTᵢ₃, on the value of the amount of energy QS_{i4,c} stored by the sub-entity S_ENTᵢ₄, and possibly on the carbon footprint Carb_{i3,c} of the energy stored by the storage sub-entity S_ENTᵢ₃, in the current time interval IT_{c}, a type of action to be implemented in the current time interval by the energy storage sub-entity S_ENTᵢ₃ is then selected.

Said selection may also be implemented by combining the abovementioned values respectively with values of the same type that are obtained by learning in previous time intervals, for example using a supervised learning algorithm. Such a selection S2ᵢ₃ is implemented in accordance with a performance criterion R_{i3,c} regarding the use of the energy stored in the current time interval.

In one exemplary embodiment, the criterion R_{i3,c} maximizes the profit from the supply of the energy stored to the other entity ENTⱼ or to the external energy supplier FE in said current time interval, if the amount of energy stored by the sub-entity S_ENTᵢ₃ in the current time interval is sold to the other entity ENTⱼ or to the external energy supplier FE.

The criterion R_{i3,c} is expressed in the form R_{i3,c}=Pr_{c,Xplace}·QS_{i3,v,c} (8), where QS_{i3,v,c} represents the amount of stored energy that is sold.

In another exemplary embodiment, more particularly if the sale price of the supplier is different from that of the marketplace, the criterion R_{i3,c} is expressed in the form R_{i3,c}=Pr_{c,grid}·QS_{i3,v,c} (9).

In a more complex exemplary embodiment, the criterion R_{i3,c} minimizes the cost of purchasing energy, from the energy supplier or from another entity of the marketplace, which should be stored in the sub-entity S_ENTᵢ₃ in said current time interval.

The criterion R_{i3,c} is then expressed in the form R_{i3,c}=−Pr_{c,Xplace}·QS_{i3,a,c} (10) or R_{i3,c}=−Pr_{c,grid}·QS_{i3,a,c} (11), where QS_{i3,a,c} represents the amount of purchased energy to be stored.

As a variant, the criterion R_{i3,c} that is used is a compromise between maximizing the profit from supplying the stored energy to the other entity ENTⱼ or to the external energy supplier FE in said current time interval and minimizing the dissatisfaction of the user of the storage sub-entity S_ENTᵢ₃ in said current time interval. Such dissatisfaction is based on the user's concern that the storage sub-entity S_ENTᵢ₃ does not have a level of charge sufficient to meet the user's needs in the current time interval.

The criterion R_{i3,c} is expressed in the form R_{i3,c}=αᵢ₃·Pr_{c,Xplace}·QS_{i3,c}−βᵢ₃·(E_{i3,max}−E_{i3,c})² (12) or R_{i3,c}=αᵢ₃·Pr_{c,grid}·QS_{i3,c}−βᵢ₃·(E_{i3,max}−E_{i3,c})² (13),

where:
αᵢ₃ and βᵢ₃ are weighting coefficients between profit related to the sale of energy and user dissatisfaction,
βᵢ₃·(E_{i3,max}−E_{i3,c})² is a factor determining the anxiety of the user of the sub-entity S_ENTᵢ₃ about not having enough energy to use this sub-entity, in which E_{i3,max} is the maximum energy consumption of this sub-entity S_ENTᵢ₃.

In another exemplary embodiment, the criterion R_{i3,c} that is used minimizes the dissatisfaction of the user of the sub-entity S_ENTᵢ₃ in said current time interval. It is then expressed in the form R_{i3,c}=−βᵢ₃·(E_{i3,max}−E_{i3,c})² (14). At the end of said selection S2ᵢ₃, the energy storage sub-entity S_ENTᵢ₃ makes a decision from among three decisions D1, D2, D3. Decision D1 relates to the choice of the energy source to recharge the storage sub-entity S_ENTᵢ₃. Decision D2 relates to the choice of the destination for the energy discharged from the storage sub-entity S_ENTᵢ₃. Decision D3 is not to implement any particular action in the following time interval.

If decision D1 has been selected as the action to be carried out, the storage sub-entity S_ENTᵢ₃:
either selects, in S3aᵢ₃, the other entity ENTⱼ and/or the energy supplier FE as the source for the recharging of the sub-entity S_ENTᵢ₃, in the following time interval,
or selects, in S3bᵢ₃, the energy production sub-entity S_ENTᵢ₁ as the source for the recharging of the sub-entity S_ENTᵢ₃, in the following time interval.

If decision D2 has been selected as the action to be carried out in the following time interval, the storage sub-entity S_ENTᵢ₃:
either selects, in S3cᵢ₃, the other entity ENTⱼ and/or the energy supplier FE as the recipient of all or part of the amount QS_{i3,c} discharged from the sub-entity S_ENTᵢ₃,
or selects, in S3dᵢ₃, the energy consumption sub-entity S_ENTᵢ₂, such as for example a device the use of which is time-shiftable, a device the operating power level of which is variable, a device the use of which is not time-shiftable and the operating power level of which is fixed, as the recipient of all or part of the amount QS_{i3,c} discharged from the sub-entity S_ENTᵢ₃.

If the selection S3aᵢ₃ is implemented, the energy storage sub-entity S_ENTᵢ₃ calculates, in S4aᵢ₃, the amount of energy Q_{i3,c} to be received from the entity ENTⱼ or from the energy supplier FE for recharging thereof in the current time interval.

If the selection S3bᵢ₃ is implemented, the energy storage sub-entity S_ENTᵢ₃ calculates, in S4bᵢ₃, the amount of energy Q_{i3,c} to be received from the energy production sub-entity S_ENTᵢ₁ for recharging thereof in the current time interval.

If the selection S3cᵢ₃ is implemented, the energy storage sub-entity S_ENTᵢ₃ calculates, in S4cᵢ₃, the amount of energy Q_{i3,c} to be used to supply energy to the other entity ENTⱼ and/or the energy supplier FE.

If the selection S3dᵢ₃ is implemented, the energy storage sub-entity S_ENTᵢ₃ calculates, in S4dᵢ₃, the amount of energy Q_{i3,c} to be used to supply energy to said at least one energy consumption sub-entity S_ENTᵢ₂.

In S5ᵢ₃, the calculated amount of energy Q_{i3,c} is then transmitted to the entity ENTᵢ, in the current time interval.

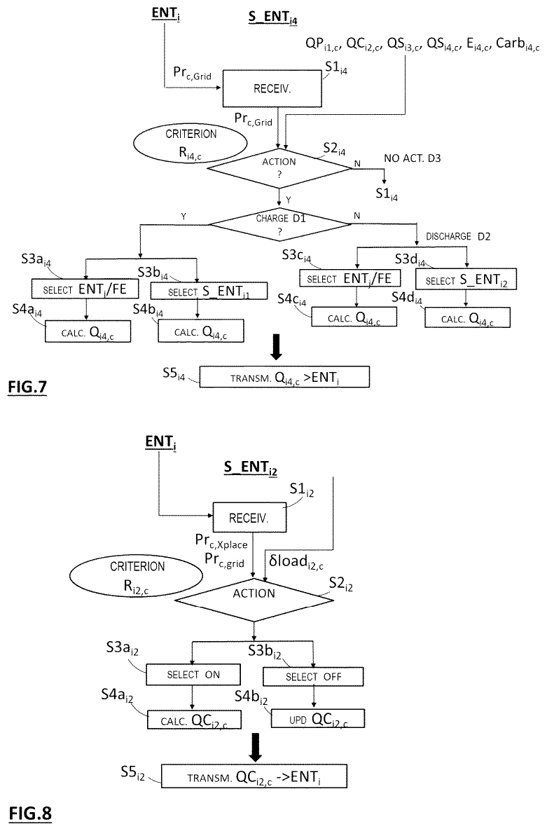

A description will now be given, with reference to FIG. 7, of the various steps carried out at said at least one electric vehicle sub-entity S_ENTᵢ₄ that is associated with said at least one entity ENTᵢ, when the energy exchange method is implemented in the current time interval IT_{c} and when such a sub-entity is present.

In S1ᵢ₄, the sub-entity S_ENTᵢ₄ receives, from the entity ENTᵢ, via a reception module identical or similar to the one from FIG. 3, the value of the cost price Pr_{c,grid} of the energy available, in said current time interval, from the energy supplier FE and/or the value of the cost price Pr_{c,Xplace} of the energy available on the marketplace, in said current time interval.

In S2ᵢ₄, based on the value of Pr_{c,grid} and/or Pr_{c,Xplace}, QS_{i4,c}, QS_{i3,c}, QP_{i1,c}, QC_{i2,c} in said current time interval, on the energy E_{i4,c} consumed by the sub-entity S_ENTᵢ₄ in said current time interval, and possibly on the carbon footprint Carb_{i4,c} of the energy stored by the sub-entity S_ENTᵢ₄ in the current time interval, a type of action to be implemented in the current time interval by the electric vehicle sub-entity S_ENTᵢ₄ is then selected.

Said selection may also be implemented by combining the abovementioned values respectively with values of the same type that are obtained by learning in previous time intervals, for example using a supervised learning algorithm. Such a selection S2ᵢ₄ is implemented in accordance with a performance criterion R_{i4,c} regarding the use of the energy stored by said sub-entity S_ENTᵢ₄, in the current time interval.

In one exemplary embodiment, the criterion R_{i4,c} maximizes the profit from the supply of the stored energy to the other entity ENTⱼ or to the external energy supplier FE in said current time interval.

The criterion R_{i4,c} is expressed in the form R_{i4,c}=Pr_{c,Xplace}·QS_{i4,v,c} (15) or R_{i4,c}=Pr_{c,grid}·QS_{i4,v,c} (16), where QS_{i4,v,c} represents the stored amount that is sold.

In a more complex exemplary embodiment, the criterion R_{i4,c} minimizes the cost of purchasing energy, from the energy supplier or from another entity of the marketplace, which should be stored in the sub-entity ENTᵢ₄ in the following time interval.

The criterion R_{i4,c} is then expressed in the form R_{i4,c}=−Pr_{c,Xplace}·QS_{i4,a,c} (17) or R_{i4,c}=−Pr_{c,grid}·QS_{i4,a,c} (18), where QS_{i4,a,c} represents the amount of purchased energy to be stored.

As a variant, the criterion R_{i4,c} that is used is a compromise between maximizing the profit from supplying the stored energy to the other entity ENTⱼ or to the external energy supplier FE in said current time interval and minimizing the dissatisfaction of the user of the electric vehicle sub-entity S_ENTᵢ₄ in said current time interval. Such dissatisfaction is based on the user's concern that the electric vehicle sub-entity S_ENTᵢ₄ does not have enough energy to operate in the current time interval.

The criterion R_{i4,c} is expressed in the form R_{i4,c}=αᵢ₄·Pr_{c,Xplace}·QS_{i4,c}−βᵢ₄·(E_{i4,max}−E_{i4,c})² (19) or R_{i4,c}=αᵢ₄·Pr_{c,grid}·QS_{i4,c}−βᵢ₄·(E_{i4,max}−E_{i4,c})² (20), where:
αᵢ₄ and βᵢ₄ are weighting coefficients between profit related to the sale of energy and user dissatisfaction,
βᵢ₄·(E_{i4,max}−E_{i4,c})² is a factor determining the anxiety of the user of the electric vehicle sub-entity S_ENTᵢ₄ about not having enough energy to use their electric vehicle, wherein E_{i4,max} is the maximum energy consumption of this sub-entity S_ENTᵢ₄ and E_{i4,c} is the energy consumption thereof during the current time interval.

In another exemplary embodiment, the criterion R_{i4,c} that is used minimizes the dissatisfaction of the user of the electric vehicle sub-entity S_ENTᵢ₄ in said current time interval. It is then expressed in the form R_{i4,c}=−βᵢ₄·(E_{i4,max}−E_{i4,c})² (21).

At the end of said selection S2ᵢ₄, the electric vehicle sub-entity S_ENTᵢ₄ makes a decision from among three decisions D1, D2, D3. Decision D1 relates to the choice of the energy source to recharge the sub-entity S_ENTᵢ₄. Decision D2 relates to the choice of the destination for the energy discharged from the sub-entity S_ENTᵢ₄. Decision D3 is not to implement any particular action in the following time interval, and in this case, the exchange method is iterated starting from step S1ᵢ₄ for the following time interval IT_{c+1}.

If decision D1 has been selected as the action to be carried out, the sub-entity S_ENTᵢ₄:
either selects, in S3aᵢ₄, the other entity ENTⱼ and/or the energy supplier FE as the source for the recharging of the sub-entity S_ENTᵢ₄,
or selects, in S3bᵢ₄, the energy production sub-entity S_ENTᵢ as the source for the recharging of the sub-entity S_ENTᵢ₄.

If decision D2 has been selected as the action to be carried out, the sub-entity S_ENTᵢ₄:
either selects, in S3cᵢ₄, the other entity ENTⱼ and/or the energy supplier FE as the recipient for the discharging of the sub-entity S_ENTᵢ₄,
or selects, in S3d₄, the energy consumption sub-entity S_ENTᵢ₂, such as for example a device the use of which is time-shiftable, a device the operating power level of which is variable, a device the use of which is not time-shiftable and the operating power level of which is fixed, as the recipient for the discharging of the sub-entity S_ENTᵢ₄.

If the selection S3aᵢ₄ is implemented, the sub-entity S_ENTᵢ₄ calculates, in S4aᵢ₄, the amount Q_{i4,c} of energy to be received from the entity ENTᵢ or from the energy supplier FE for recharging thereof in the current time interval.

If the selection S3bᵢ₄ is implemented, the sub-entity S_ENTᵢ₄ calculates, in S4bᵢ₄, the amount Q_{i4,c} of energy to be received from the energy production sub-entity S_ENTᵢ₁ for recharging thereof in the current time interval.

If the selection S3cᵢ₄ is implemented, the sub-entity S_ENTᵢ₄ calculates, in S4cᵢ₄, the amount Q_{i4,c} of energy to be used to supply energy to the other entity ENTⱼ and/or the energy supplier FE.

If the selection S3dᵢ₄ is implemented, the sub-entity S_ENTᵢ₄ calculates, in S4dᵢ₄, the amount Q_{i4,c} of energy to be used to supply energy to said at least one energy consumption sub-entity S_ENTᵢ₂.

In S5ᵢ₄, the calculated amount Q_{i4,c} of energy is then transmitted to the entity ENTᵢ, in the current time interval.

A description will now be given, with reference to FIG. 8, of the various steps carried out at said at least one energy consumption sub-entity S_ENTᵢ₂ that is associated with said at least one entity ENTᵢ, when the energy exchange method is implemented in the current time interval IT_{c} and when such a sub-entity is present. In the example in FIG. 8, the architecture of the set of entities is on only two levels L1 and L2, the energy-consuming devices associated with the sub-entity S_ENTᵢ₂ all being located at the level L2, regardless of their type.

In S1ᵢ₂, the sub-entity S_ENTᵢ₂, which is located at the level L2, receives, from the entity ENTᵢ, which is located at the level L1, via a reception module identical or similar to the one from FIG. 3, the value of the cost price Pr_{c,grid} of the energy available, in said current time interval, from the energy supplier FE, and the value of the cost price Pr_{c,Xplace} of the energy available, in said current time interval, from the other entity ENTⱼ.

In S22, based on the value of the price Pr_{c,grid} and of the price Pr_{c,Xplace}, on the power consumption δload_{i2,c} of the set of energy-consuming devices corresponding to the sub-entity S_ENTᵢ₂, a type of action to be implemented in the current time interval by the sub-entity S_ENTᵢ₂ is then selected.

Said selection may also be implemented by combining the values Pr_{c,grid}, Pr_{c,Xplace}, δload_{i2,c} respectively with values of the same type that are obtained by learning in previous time intervals, for example using a supervised learning algorithm.

Such a selection S2ᵢ₂ is implemented in accordance with a performance criterion R_{i2,c} regarding the use of the energy to be consumed in the current time interval.

In one exemplary embodiment, the criterion R_{i2,c} minimizes the dissatisfaction of a user of the one or more energy-consuming devices, said criterion being related:
either to a shift in the use of all or some of the devices to a time interval following the current time interval, if these one or more devices has or have a time-shiftable use profile,
or to a decrease in the power level of all or some of the devices in the current time interval, if this or these devices has or have a power-shiftable use profile.

$${R}_{i 2 , c} = - {\sum }_{k = 1}^{N} {P}_{k , c} , \qquad ( 22 )$$

The criterion R_{i2,c} is expressed in the form where N represents the number of devices the use of which is time-shiftable and P_{k,c} represents the operating power of a device k from among N. If this device is turned off during a time interval, P_{k,c}=0 during this interval.

In another exemplary embodiment, the criterion R_{i2,c} is expressed in the form

$${R}_{i 2 , c} = - {\sum }_{k = 1}^{N} {P}_{k} * ( \frac{{Pr}_{c , Xplace} + {Pr}_{c , grid}}{2} ) , \qquad ( 23 )$$

where an average of the values of the prices Pr_{c,Xplace} and Pr_{c,grid} is used, for example.

This criterion may also be defined as a weighted sum between the energy consumption (or else the power) of the energy-consuming devices and the dissatisfaction of the user, both of which are to be minimized.

The criterion R_{i2,c} is expressed in the form

$${R}_{i 2 , c} = {\sum }_{k = 1}^{N} {R}_{k , c} \qquad ( 24 )$$

if k devices associated with the sub-entity S_ENTᵢ₂ remain in operation in the current time interval, where

$${\sum }_{k = 1}^{N} {R}_{k , c}$$

represents the sum of the energy performance criteria applied individually for each of the k devices.

At the end of said selection S2ᵢ₂, the sub-entity S_ENTᵢ₂:
either leaves the one or more energy-consuming devices associated therewith in operation S3aᵢ₂ during the current time interval,
or switches off S3bᵢ₂ these one or more devices, during the current time interval.

If the selection S3aᵢ₂ is implemented, the sub-entity S_ENTᵢ₂ calculates, in S4aᵢ₂, the amount QC_{i2,c} of energy to be consumed in the current time interval. If the selection S3bᵢ₂ is implemented, in S4bᵢ₂, the sub-entity S_ENTᵢ₂ updates the amount QC_{i2,c} of energy to be consumed in the current time interval on the basis of the devices that remain in operation in the current time interval.

In S5ᵢ₂, the sub-entity S_ENTᵢ₂ transmits, to the entity ENTᵢ, the amount QC_{i2,c} of energy to be consumed in the current time interval, which was obtained in S3aᵢ₂ or S3bᵢ₂.

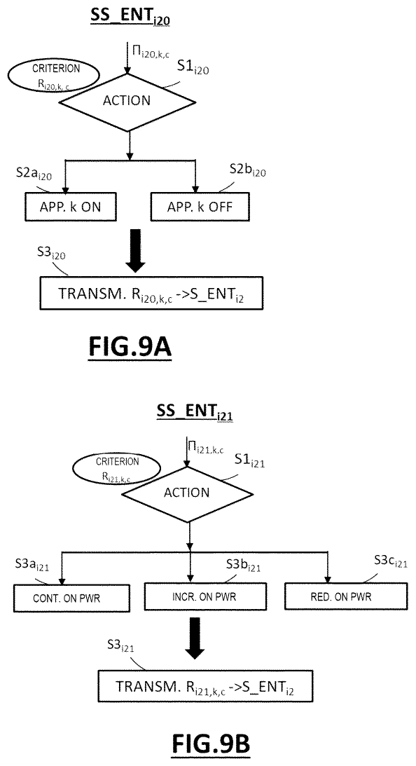

A description will now be given, with reference to FIG. 9A, of the various steps carried out at at least one energy consumption sub-entity SS_ENTᵢ₂₀ that is associated with said at least one energy consumption sub-entity S_ENTᵢ₂, when the energy exchange method is implemented in the current time interval IT_{c} and the sub-entity S_ENTᵢ₂ has decided to leave the one or more energy-consuming devices forming the sub-entity SS_ENTᵢ₂₀ in operation. To this end, in this decision context, in the example of FIG. 9A, the architecture of the set of entities is on three levels L1, L2, L3 and the sub-entity SS_ENTᵢ₂₀ that is located at the level L3 comprises M energy-consuming devices of the abovementioned type, the use of which is time-shiftable.

In S1ᵢ₂₀, the sub-entity SS_ENTᵢ₂₀ selects, for a kth device from among M, a corresponding action a_{i20,c} from among two possible actions ACT1, ACT2, which are as follows:
ACT1: the kth device remains in operation in the following time interval,
ACT2: the kth device stops operating in the following time interval.

Step S1ᵢ₂₀ is iterated for each of the M devices of the sub-entity SS_ENTᵢ₂₀. Such a selection S1ᵢ₂₀ is implemented on the basis of a prior parameterization Π_{i20,c} of the user, according to which the user has indicated which of the M time-shiftable devices are those the operation of which should be maintained and those whose operation should be stopped. Such parameterization is conventional and may be implemented for example via a home automation application installed on a terminal or a home control station, or else via a website dedicated to the service offering the energy exchange.

Such a selection is implemented in accordance with an energy performance criterion R_{i20,c}.

In one exemplary embodiment, the criterion R_{i20,c} minimizes the dissatisfaction of a user that might be related to a shift in the use of a kth time-shiftable device, in a time interval later than the current time interval.

The criterion R_{i20,c} is expressed for example in the following form:

$${R}_{i 20 , c} = - {ε}_{i 20} {\sum }_{k = 1}^{M} {P}_{i 20 , k} {a}_{i 20 , c} [ k ] - ( 1 - {ε}_{i 20} ) {\sum }_{k = 1}^{M} {δ}_{i 20 , k} ( 1 - {a}_{i 20 , c} [ k ] ) , \qquad ( 25 )$$

where:
P_{i20,k} is the operating power of the kth device,
α_{i20,c} is the action chosen at the end of the current interval IT_{c}; this is a vector representing the decisions made for the set of M devices: for example, if the sub-entity SS_ENTᵢ₂₀ is representative of M=5 devices and the action is to shift the use of each of them, then α_{i20,c}=[0, 0, 0, 0, 0],
εᵢ₂₀ is a weighting coefficient,
δ_{i20,k} represents a user dissatisfaction coefficient for a kth device of the sub-entity SS_ENTᵢ₂₀.

In another exemplary embodiment, the criterion R_{i20,c} could for example minimize the energy consumption in the event of a peak load in order to avoid the purchase of energy at a high price.

At the end of said selection S1ᵢ₂₀, each of the M devices of the sub-entity SS_ENTᵢ₂₀:
either remains in operation in S2aᵢ₂₀, during the following time interval,
or is switched off at S2bᵢ₂₀, during the following time interval.

In S3ᵢ₂₀, the sub-entity SS_ENTᵢ₂₀ transmits the criterion R_{i20,c} to the sub-entity S_ENTᵢ₂.

A description will now be given, with reference to FIG. 9B, of the various steps carried out at at least one energy consumption sub-entity SS_ENTᵢ₂₁ that is associated with said at least one energy consumption sub-entity S_ENTᵢ₂, when the energy exchange method is implemented in the current time interval IT_{c} and the sub-entity S_ENTᵢ₂ has decided to vary the power level of the energy-consuming devices forming the sub-entity SS_ENTᵢ₂₁. To this end, in this decision context, in the example of FIG. 9B, the architecture of the set of entities is on three levels L1, L2, L3 and the sub-entity SS_ENTᵢ₂₁ that is located at the level L3 comprises N energy-consuming devices of the abovementioned type, the power level of which is time-variable.

In S1ᵢ₂₁, the sub-entity SS_ENTᵢ₂₁ selects, for a kth device from among N, an action from among three possible actions ACT3, ACT4, ACT5, which are as follows:
ACT3: the kth device continues to operate in the following time interval, with the same power level as in the current time interval,
ACT4: the kth device continues to operate in the following time interval, with a power level higher than that applied in the current time interval,
ACT5: the kth device continues to operate in the following time interval, with a power level lower than that applied in the current time interval.

Step S1ᵢ₂₁ is iterated for each of the N devices of the sub-entity SS_ENTᵢ₂₁.

Such a selection S1ᵢ₂₁ is implemented on the basis of a prior parameterization Π_{i21,c} of the user, according to which the user has indicated which of the N variable-power devices are those for which the power level remains fixed, those for which the power level may be increased, and those for which the power level may be reduced. Such parameterization is conventional and may be implemented in a manner similar to the example from FIG. 9A.

Such a selection is implemented in accordance with an energy performance criterion R_{i21,c}.

In one exemplary embodiment, the criterion R_{i21,c} minimizes the dissatisfaction of a user that might be related to a reduction in the power level of a kth device from among N, in the current time interval.

The criterion R_{i21,c} is expressed for example in the following form:

$${R}_{i 21 , c} = - {ε}_{i 21} {\sum }_{k = 1}^{N} {a}_{i 21 , c} [ k ] - ( 1 - {ε}_{i 21} ) {\sum }_{k = 1}^{N} {δ}_{i 21 , k} ( {P}_{i 21 , max} [ k ] - {a}_{i 21 , c} [ k ] ) , \qquad ( 26 )$$

where:
α_{i21,c} is the action chosen at the end of the current interval IT_{c}, α_{i21,c} being a vector of decisions made for the set of N devices of the sub-entity SS_ENTᵢ₂₁ regarding the power level to be used from among the levels available for each of them: for example, if the sub-entity SS_ENTᵢ₂₁ is representative of 3 devices and the possible values for each of them are [P₁, P₂, P₃, P₄, P₅] and the action chosen at the end of the current time interval IT_{c} is to use the power level P₁ for the first two devices and the power level P₃ for the third device, then the action will be written as follows: aα_{i21,c}=[P₁, P₁, P₃],
εᵢ₂₁ is a weighting coefficient,
P_{i21,max} is a vector representative of the maximum operating powers for all of the devices the power level of which is variable,
δ_{i21,k} represents a user dissatisfaction coefficient for a kth device of the sub-entity SS_ENTᵢ₂₁ for which the power level is variable.

In another exemplary embodiment, the criterion R_{i21,c} minimizes the power consumption in the event of a load peak for example.

At the end of said selection S1ᵢ₂₁, the operation of each of the N devices of the sub-entity SS_ENTᵢ₂₁:
is activated in S2aᵢ₂₁, during the following time interval, with the same power level as that applied in the current time interval,
is activated in S2bᵢ₂₁, during the following time interval, with a power level higher than that applied in the current time interval,
is activated in S2cᵢ₂₁, during the following time interval, with a power level lower than that applied in the current time interval.

In S3ᵢ₂₁, the sub-entity SS_ENTᵢ₂₁ transmits the criterion R_{i21,c} to the sub-entity S_ENTᵢ₂.

### Description of a Second Embodiment of an Entity Able to Exchange Energy

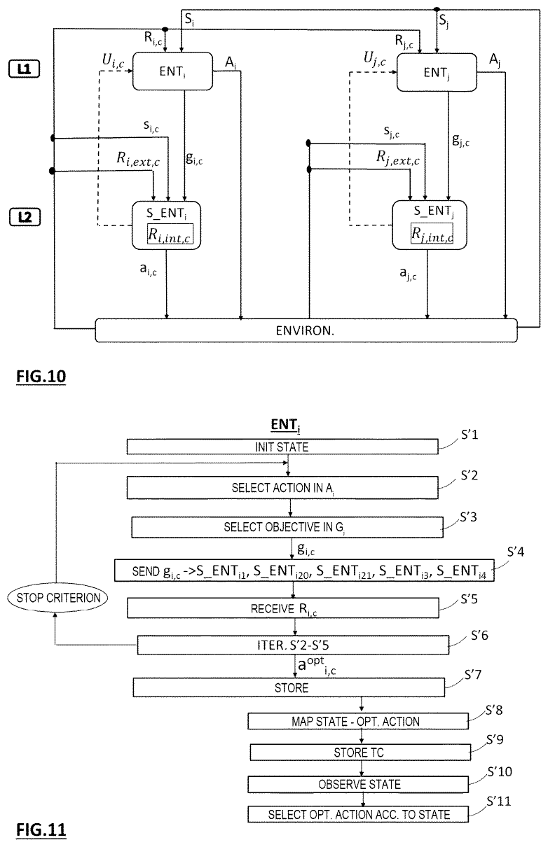

A description will now be given, with reference to FIG. 10, of the simplified structure of an entity ENTᵢ chosen from among the plurality of entities ENT₁ to ENT_{K} from FIG. 2, such that for example 1≤K≤Ne, according to a second embodiment of the invention.

Such an entity ENTᵢ is configured to implement the energy exchange method that will be described below and that is implemented using a reinforcement learning algorithm.

To this end, the entity ENTᵢ is an agent that operates in a multi-agent scenario involving at least one other agent ENTⱼ located at the same level L1.

In the particular embodiment of FIG. 10, the agent ENTᵢ comprises at least one sub-agent S_ENTᵢ located at the lower level L2, said at least one sub-agent belonging for example to the following sub-agents:
an energy production sub-agent S_ENTᵢ₁,
at least one device S_ENTᵢ₂₀ the use of which is time-shiftable,
at least one device S_ENTᵢ₂₁ the operating power level of which is variable,
an energy storage sub-agent S_ENTᵢ₃,
an electric vehicle S_ENTᵢ₄,
etc.

In the example shown in FIG. 10, the agent ENTᵢ, in a current time interval IT_{c}, carries out a certain action a_{i,c} belonging to an action space Aᵢ as follows: do nothing,
request energy from an external energy supplier FE or from at least one of the K−1 other agents,
supply energy to the external energy supplier FE or to at least one of the K−1 other agents,
determine the amount of energy to be requested (to be purchased) or to be supplied (to be sold). The agent ENTᵢ also chooses, in a current time interval IT_{c}, an objective for each of the sub-agents of the lower level L2. These objectives belong to predefined sets of objectives that will be described below.

In the same way, in this time interval IT_{c}, each of the K−1 other agents defining an energy marketplace is an agent that carries out one of the abovementioned actions and chooses an objective for each of its sub-agents of the lower level L2.

In order to select the action that optimizes this energy exchange in the current time interval IT_{c}, the agent ENTᵢ explores its environment, which is represented by a state belonging to a state space Sᵢ that will be described in the remainder of this description, or else uses the result of its learning and selects the action that has proved best up to now.

To this end, the agent ENTᵢ carries out various actions, such as those of the abovementioned action space, for a given state s_{i,c} of the state space Sᵢ, providing a reward R_{i,c} that defines a performance criterion regarding the exchange of energy in the marketplace. Ric is a signal that defines the reward (or else the cost) of having performed the action a_{i,c} while being in the state s_{i,c}. This information is transmitted from the environment to the agent, which seeks to optimize it (maximize it in case of reward and minimize it if it is a cost) in order to learn the best actions to carry out in each state. In the example shown, R_{i,c} may be representative of the reduction of expenditure and/or of the maximization of revenue and/or of the reduction of the carbon footprint related to the energy transaction, in the current time interval IT_{c}.

In the same way, in this time interval IT_{c}, each of the K−1 other agents explores its corresponding environment, in particular the entity ENTⱼ from FIG. 10, which carries out various actions, such as those of the action space Aⱼ, for a given state s_{j,c} of a state space Sⱼ, providing a reward R_{j,c} that defines the reward (or else the cost) of having performed the action a_{j,c} while being in the state S_{j,c}.

According to the invention, and as already explained for the abovementioned first embodiment, the agent ENTᵢ, respectively the agent ENTⱼ, is broken down into sub-agents arranged at the hierarchical level L2, of which only a single sub-agent S_ENTᵢ, respectively S_ENTⱼ, is shown for the sake of simplifying FIG. 10.

At the level L2, the sub-agent S_ENTᵢ, respectively S_ENTⱼ, receives information from the agent ENTᵢ, respectively ENTⱼ, which defines an objective to be achieved to implement the optimum energy exchange strategy defined by R_{i,c} (respectively R_{j,c}). This information may be added to the state S_{i,c}, respectively S_{j,c}, of the sub-agent S_ENTᵢ, respectively S_ENTⱼ.

To this end, the sub-agent S_ENTᵢ, respectively S_ENTⱼ, in the current time interval IT_{c}, carries out the action a_{i,c}, respectively a_{j,c}, which aims to distribute the energy for the agent ENTᵢ, respectively the agent ENTⱼ, in optimum fashion. When the agent ENTᵢ is broken down for example into five sub-agents S_ENTᵢ₁, S_ENTᵢ₂₀, S_ENTᵢ₂₁, S_ENTᵢ₃, S_ENTᵢ₄, each of them, in the current time interval, carries out the respective actions a_{i,c}, a_{i20,c}, a_{i21,c}, a_{i3,c}, a_{i4,c} which, together, aim to distribute the energy for the agent ENTᵢ in optimum fashion.

The action a_{i1,c} carried out by the sub-agent S_ENTᵢ₁, in the current time interval IT_{c}, is predefined, such an action being chosen from the following action space:
do nothing,
select the other agent ENTⱼ and/or the energy supplier FE as the recipient of all or some of the energy produced,
supply energy to the sub-agent S_ENTᵢ₂₀ and/or the sub-agent S_ENTᵢ₂₁,
recharge the energy storage sub-agent S_ENTᵢ₃ with all or some of the energy produced,
recharge the sub-agent S_ENTᵢ₄ with all or some of the energy produced.

In order to select the action a_{i1,c} that optimizes the distribution or the use of energy in the current time interval IT_{c}, the sub-agent ENTᵢ₁ explores its environment, which is represented by a state belonging to a state space Sᵢ₁ that will be described in the remainder of this description. To this end, the sub-agent S_ENTᵢ₁ carries out various possible actions, such as those of the abovementioned action space, for a given state, providing a reward R_{i1,c} that defines a performance criterion regarding the use of the energy produced by this sub-agent S_ENTᵢ₁. In the example shown, R_{i1,c} may be representative for example of the maximization of revenue in the current time interval IT_{c}, if the energy produced is supplied to the energy supplier FE or to the other agent ENTⱼ.

According to this second embodiment, the sub-agent S_ENTᵢ₂₀, in the current time interval, carries out the action a_{i20,c} that aims to best adapt the energy consumption for the agent ENTᵢ. Depending on the context of the energy exchange, if a sub-agent S_ENTᵢ₂₁ is present at the level L2, the action a_{i20,c} is implemented in conjunction with the action a_{i21,c} implemented by the sub-agent S_ENTᵢ₂₁ with a view to best adapting the energy consumption for the agent ENTᵢ.

The action a_{i20,c} carried out by the sub-agent S_ENTᵢ₂₀, in the current time interval IT_{c}, is predefined, such an action being chosen from the following action space Aᵢ₂₀:
operate,
do not operate.

In order to select the action a_{i20,c} that optimizes the distribution or the use of energy in the current time interval IT_{c}, the sub-agent S_ENTᵢ₂₀ explores its environment, which is represented by a state belonging to a state space Sᵢ₂₀ that will be described in the remainder of this description. To this end, the sub-agent S_ENTᵢ₂₀ carries out various possible actions, such as those of the abovementioned action space Aᵢ₂₀, for a given state, providing a reward R_{i20,c} that defines an energy performance criterion related to the use of the energy consumed by this sub-agent S_ENTᵢ₂₀. In the example shown, R_{i20,c} may define for example the minimization of the dissatisfaction of the user in the current time interval IT_{c}, in the case of a shift in the use of the sub-agent S_ENTᵢ₂₀ and the minimization of energy consumption in the event of a load peak in order to avoid the purchase of energy at a high price.

The action a_{i21,c} carried out by the sub-agent S_ENTᵢ₂₁, in the current time interval IT_{c}, is predefined, such an action being chosen from the following action space Aᵢ₂₁:
keep the same power as that applied in the previous time interval,
reduce the power,
increase the power.

In order to select the action a_{i21,c} that optimizes the consumption of energy in the current time interval IT_{c}, in this time interval IT_{c}, the sub-agent S_ENTᵢ₂₁ explores its environment, which is represented by a state belonging to the state space Sᵢ₂₁ and that will be described in the remainder of this description. To this end, the sub-agent S_ENTᵢ₂₁ carries out various possible actions, such as those of the abovementioned action space, for a given state of the state space Sᵢ₂₁, providing a reward R_{i21,c} that defines a criterion regarding optimization of the consumption of energy by the sub-agent S_ENTᵢ₂₁. In the example shown, R_{i21,c} may be representative of the minimization of the dissatisfaction of the user related to the reduction of the operating power level of the sub-agent S_ENTᵢ₂₁ and of the minimization of power consumption in the event of peak loads, for example, in order to avoid the purchase of energy at a high price.

According to this second embodiment, the action a_{i3,c} carried out by the sub-agent S_ENTᵢ₃, in the current time interval IT_{c}, is predefined, such an action being chosen from the following action space Aᵢ₃:
do nothing, that is to say neither recharge with energy nor discharge energy,
sell energy to at least one of the K−1 other agents, ENTⱼ for example,
sell energy to the external energy supplier FE,
supply energy to the sub-agent S_ENTᵢ₂₀ and/or the sub-agent S_ENTᵢ₂₁,
recharge with energy from at least one of the K−1 other agents, ENTⱼ for example,
recharge with energy from the external energy supplier FE,
recharge with energy from the sub-agent S_ENTᵢ₁.

In order to select the action a_{i3,c} that optimizes the use of the energy stored in the current time interval IT_{c}, the sub-agent ENTᵢ₃ explores its environment, which is represented by a state belonging to a state space Sis that will be described in the remainder of this description. To this end, the sub-agent S_ENTᵢ₃ carries out various possible actions, such as those of the abovementioned action space, for a given state, providing a reward R_{i3,c} that defines an energy performance criterion related to the use of the energy stored by this sub-agent S_ENTᵢ₃. In the example shown, R_{i3,c} may define the maximization of the duration of the life cycle of said at least one storage sub-agent S_ENTᵢ₃.

According to this second embodiment, the action a_{i4,c} carried out by the sub-agent S_ENTᵢ₄, in the current time interval IT_{c}, is predefined, such an action being chosen from the following action space Aᵢ₄:
do nothing, that is to say neither recharge with energy nor discharge energy,
sell energy to at least one of the K−1 other agents, ENTⱼ for example,
sell energy to the external energy supplier FE,
supply energy to the sub-agent S_ENTᵢ₂₀ and/or the sub-agent S_ENTᵢ₂₁,
recharge with energy from at least one of the K−1 other agents, ENTⱼ for example,
recharge with energy from the external energy supplier FE,
recharge with energy from the sub-agent S_ENTᵢ₁.

In order to select the action a_{i4,c} that optimizes the use of the energy stored in the current time interval IT_{c}, the sub-agent S_ENTᵢ₄ explores its environment, which is represented by a state belonging to a state space Sᵢ₄ that will be described in the remainder of this description. To this end, the sub-agent S_ENTᵢ₄ carries out various possible actions, such as those of the abovementioned action space, for a given state, providing a reward R_{i4,c} that defines an energy performance criterion related to the use of the energy stored by this sub-agent S_ENTᵢ₄. In the example shown, R_{i4,c} may define the dissatisfaction of the user based on the concern that the electric vehicle sub-agent S_ENTᵢ₄ does not have enough energy to operate in the current time interval. As a variant, R_{i4,c} may be representative of the maximization of the duration of the life cycle of said at least one sub-agent S_ENTᵢ₄.

The embodiment described in connection with FIG. 10 is particularly advantageous for the following reasons:
it uses a reinforcement learning algorithm that is particularly effective in terms of modeling a sequential decision-making system or a multi-agent energy marketplace with complex state spaces and action spaces. Moreover, it is well suited to the hierarchical breakdown, according to the invention, of the energy marketplace, where sequential decisions are implemented by the agents or corresponding sub-agents on multiple levels, for example two levels L1, L2 in the example shown in FIG. 10,
it is based on a hierarchical breakdown of an agent into various sub-agents related to a specific energy use profile (energy consumption, storage, production, electric vehicle, etc.), such a breakdown making it possible to reduce the action spaces and the state spaces while still preserving the scalability of the energy marketplace or of the energy exchange system,
it makes it possible to operate on diverse time scales: for example, the energy exchange strategy at the level L1 may be defined on a daily basis, while the energy use strategies on the lower level L2 may be defined over shorter times, for example one or more hours, one or more minutes, etc. Such hierarchical operation makes it possible to speed up reinforcement learning for the energy marketplace or the energy exchange system,
the modularity of the energy exchange system on various levels L1, L2 makes it much easier to transfer learning between agents having the same characteristics, thereby also contributing to this speeding up of reinforcement learning. Reinforcement learning thus makes it possible to optimize the efficiency of the energy exchange on the energy marketplace or the energy exchange system,
the breakdown of the energy exchange system into multiple hierarchical levels allows better protection of the user's personal data concerning the sub-agents of the lower levels L2 of the energy marketplace or of the energy exchange system, with little information related to these lower levels being transmitted to entities or agents of the higher level.

### Description of a Second Embodiment of an Energy Exchange Method

A description will now be given, with reference to FIG. 11, of the sequence of an energy exchange method carried out by the agent ENTᵢ, as illustrated in FIG. 10.

Such an energy exchange method takes place as follows at the agent ENTᵢ, in a current time interval IT_{c}.

In S′1, a given state of the energy exchange system is initialized in the current time interval IT_{c}.

In one preferred embodiment, the state space Sᵢ configured for the system is for example as follows:

$${S}_{i} = P {r}_{grid} \times {Pr}_{Xplace} \times {Q}_{i 1 , v} \times {Q}_{cons} \times H \times {U}_{i 3} \times {U}_{i 4} , \qquad ( 27 )$$

Pr_{grid} and Pr_{Xplace} are respectively the set of possible values for the prices coming from the traditional supplier FE and from the marketplace; they may be defined as two intervals between a minimum price and a maximum price (which are to be defined) with values that are either continuous or discrete between the two,
Q_{i1,v} is the amount of energy produced by the sub-agent S_ENTᵢ₁ and sold to the traditional supplier FE or to the marketplace;
Q_{cons} is the set defining the possible values for the amount of energy consumed during a predefined time interval; Q_{cons} may be defined as an interval between a minimum consumption value and a maximum consumption value, such that Q_{cons}=[Q_{cons,min}, Q_{cons,max}], with continuous or discrete values between the two;
H is the set defining the time: H=[0, 23];
Uᵢ₃ (respectively Uᵢ₄) is a vector consisting of the amount of energy to be sold by the sub-agent S_ENTᵢ₃ (respectively S_ENTᵢ₄) and the carbon footprint Carbis(respectively Carbᵢ₄), which is the set of possible values for carbon footprints in the sub-agent S_ENTᵢ₃ (respectively S_ENTᵢ₄), where Carbis(respectively Carbᵢ₄) may be between a predefined minimum value and a predefined maximum value.

In S′2, the agent ENTᵢ selects an action according to a compromise between using the learning result and exploring the action space, with a given probability (for example 0.9 for use and 0.1 for exploration).

In one preferred embodiment, the action is selected from an action space Aᵢ, which is for example as follows:

$${A}_{i} = {T}_{i} \times {Qt}_{i} \times {Sb}_{i} \times Ssi \times {D}_{i} \times {Pr}_{i , v} \qquad ( 28 )$$

where:
Tᵢ represents the vector defining possible energy transactions. It is a vector with three values, Tᵢ={−1, 1, 0}, where −1 is representative of an energy purchase from the supplier FE or from at least one of the K−1 other agents, 1 is representative of an energy sale to the supplier FE or to at least one of the K−1 other agents, and 0 is representative of no energy transaction action,
Qtᵢ is the set defining the possible values for the amount of energy to be purchased or to be sold during a predefined time interval; Qtᵢ may be defined as an interval between 0 and a maximum consumption value, such that Qtᵢ=[0, Qt_{i,max}], with continuous or discrete values between the two,
Sbᵢ is the set defining the source of the energy purchased by the agent ENTᵢ in a given time interval, Sbᵢ being a vector with two values, for example Sbᵢ={1, 2}, where 1 is representative of the energy supplier FE and 2 is representative of the marketplace,
Ssᵢ is the set defining the source of the energy sold by the agent ENTᵢ in a given time interval, Ssᵢ being a vector with three values, for example Ssᵢ={1, 2, 3}, where 1 is representative of the energy-producing sub-agent S_ENTᵢ₁, 2 is representative of the energy storage sub-agent S_ENTᵢ₃, 3 is representative of the electric vehicle sub-agent S_ENTᵢ₄,
Dᵢ is the set defining the destination for the energy purchased by the agent ENTᵢ in a given time interval, Dᵢ being a vector with four values, for example Dᵢ={1, 2, 3}, where 1 is representative of the energy storage sub-agent S_ENTᵢ₃, 2 is representative of the electric vehicle sub-agent S_ENTᵢ₄, 3 is representative of the energy-consuming devices,
Pr_{i,v} is a set defining the possible values of the sale price of the energy offered by the agent ENTᵢ, and may be defined as an interval between a minimum price and a maximum price (which are to be defined) with values that are either continuous or discrete between the two.

In S′3, the agent ENTᵢ selects an objective for each sub-entity according to a compromise between using the learning result and exploring the action space, with a given probability (for example 0.9 for use and 0.1 for exploration).

In one preferred embodiment, each objective is selected from an objective space G_{i,c}, which is for example as follows:

$${G}_{i} = {G}_{i 1} \times {G}_{i 20} \times {G}_{i 21} \times {G}_{i 3} \times {G}_{i 4} , \qquad ( 29 )$$

Gᵢ₁ is the objective space concerning the photovoltaic panel sub-agent S_ENTᵢ₁, such that Gᵢ₁={0,1}, where:
0 means stop the photovoltaic panel S_ENTᵢ₁ (this may be useful for energy balancing: input=output) or else continue not to use it if it is already switched off,
1 means turn it on/or keep it on if it is already operational;
Gᵢ₂₀ is the objective space concerning the time-shiftable devices S_ENTᵢ₂₀, such that Gᵢ₂₀={0,1}, where:
0 means do not use the functionality of adjusting the operating time of the devices, 1 means activate this functionality;
Gᵢ₂₁ is the objective space concerning the devices S_ENTᵢ₂₁ the power level of which is time-adjustable, such that Gᵢ₂₁={0,1}, where:
0 means do not use the functionality of adjusting the power level of the devices,
1 means activate this functionality;
Gᵢ₃ is the objective space concerning the energy storage sub-agent S_ENTᵢ₃, such that Gᵢ₃={0, 1, 2}, where:
0 means do nothing,
1 means discharge the energy storage sub-agent S_ENTᵢ₃,
2 means charge this sub-agent;
Gᵢ₄ is the objective space concerning the electric vehicle sub-agent
S_ENTᵢ₄, such that: {0, 1, 2} where:
0 means do nothing,
1 means discharge the vehicle,
2 means charge it.

At the end of this selection, an objective g_{i,c}, in a current time interval IT_{c}, may be a combination of the various possible values belonging to the sets Gᵢ₁, Gᵢ₂₀, Gᵢ₂₁, Gᵢ₃, Gᵢ₄, for example:
g_{i,c}={0, 0, 0, 1, 1} means that the agent ENTᵢ of the level L1 transmits an instruction to each of the sub-agents S_ENTᵢ₁, S_ENTᵢ₂₀, S_ENTᵢ₂₁, S_ENTᵢ₃, S_ENTᵢ₄ of the lower level L2 to stop the operation or to continue the stoppage, if this is already the case, of the sub-agents S_ENTᵢ₁, to deactivate the functionality of adjusting the use of the sub-agents S ENTᵢ₂₀ and S_ENTᵢ₂₁, and to discharge the sub-agents S_ENTᵢ₃ and S_ENTᵢ₄,
or else g_{i,c}={1, 1, 1, 1, 1} means that the agent ENTᵢ of the level L1 transmits an instruction to each of the sub-agents S_ENTᵢ₁, S_ENTᵢ₂₀, S_ENTᵢ₂₁, S_ENTᵢ₃, S_ENTᵢ₄ of the lower level L2 to respectively command the operation or the continuation of the operation of the sub-agent S_ENTᵢ₁, activate the functionality of adjusting the use of the sub-agent S_ENTᵢ₂₀, activate the functionality of adjusting the power of the sub-agent S_ENTᵢ₂₁, and activate the discharging of the sub-agents S_ENTᵢ₃ and S_ENTᵢ₄.

In S′4, each of the five values of the objective g_{i,c} is sent respectively to each of the corresponding sub-agents S_ENTᵢ₁, S_ENTᵢ₂₀, S_ENTᵢ₂₁, S_ENTᵢ₃, S_ENTᵢ₄, and will then form part of their corresponding state.

In S′5, the agent ENTᵢ receives, from its environment, a reward signal R_{i,c}, which is for example as follows in one preferred embodiment:
R_{i,c}=α_{i,c}·t_{i,c}·profit−β_{i,c}·carbon_footprint (30), where:
t_{i,c} is the type of action chosen at the end of the current interval IT_{c} for the following time interval, t_{i,c} ∈Tᵢ,

$$Profit = P {r}_{c , grid} q {t}_{i , c} \qquad ( 31 )$$

$$if {sb}_{i , c} = 1 and Profit = {Pr}_{c , Xplace} \cdot {qt}_{i , c} \qquad ( 32 )$$

$$if {sb}_{i , c} = 2 ,$$

where sb_{i,c} ∈ Sbᵢ and qt_{i,c} ∈ Qtᵢ,
carbon_footprint is a carbon footprint factor that corresponds to the carbon footprint transmitted by the energy supplier FE or at least one of the K−1 other agents from which the agent ENTᵢ purchased the energy,
α_{i,c} and β_{i,c} are two weighting coefficients between profit and carbon footprint.

As a variant, Profit=pr_{i,v,c}·qt_{i,c} (33) if t_{i,c}=1 and R_{i,c}=0 if t_{i,c}=0, where pr_{i,v,c}∈ Pr_{i,v}, and represents a sale price that is not fixed in advance, for example a price derived following an auction.

Steps S′2 to S′5 are iterated in S′6 up to a stop criterion, so as to select, for each given state, an optimum action a^{opt}_{i,c} from among Aᵢ, that is to say an optimum vector value for t_{i,c}, qt_{i,c}, sb_{i,c}, ss_{i,c}, d_{i,c}, pr_{i,v,c} for given values of Pr_{c,grid}, Pr_{c,Xplace}, Q_{i1,v}, Q_{i3,v}, Q_{i4,v}, Q_{cons}, H, Uᵢ₃, Uᵢ₄.

Such an optimum action a^{opt}_{i,c} is recorded in S′7 in a dedicated memory. In one particular embodiment, the optimum action a^{opt}_{i,c} is stored so as possibly to be selected in the following time interval in response to either use or exploration.

In another particular embodiment, steps S′1 to S′7 may be carried out prior to the marketplace being put into real-time operation, in a phase of simulating the operation of this marketplace, in order to obtain, in S′8, a mapping between each possible state and the corresponding optimum action and store this mapping in S′9 in the form of a correspondence table TC, for example.

Thus, when the marketplace operates in real time, in S′10, the agent ENTᵢ observes its state, for example, and then, in S′11, selects the action that has proved to be optimum directly from the table TC.

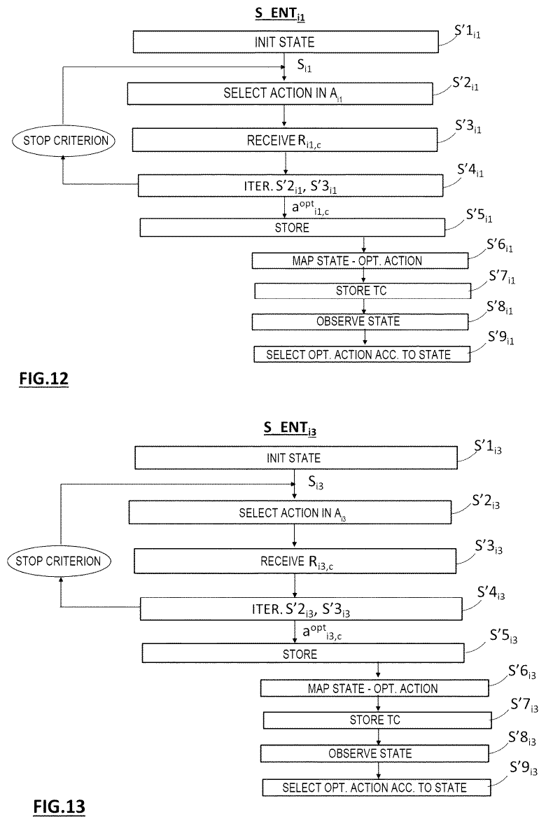

A description will now be given, with reference to FIG. 12, of the sequence of an energy distribution method carried out by the sub-agent S_ENTᵢ₁ as illustrated in FIG. 10, in the context of the energy exchange method from FIG. 11.

Such an energy distribution method takes place as follows at the sub-agent S_ENTᵢ₁, in a current time interval IT_{c}.

In S′1ᵢ₁, a given state of the energy exchange system is initialized in the current time interval IT_{c}.

In one preferred embodiment, the state space Sᵢ₁ configured for the system is for example as follows:

$${S}_{i 1} = P {r}_{grid} \times {Pr}_{Xplace} \times {Q}_{i 1 , pr} \times {CH}_{i 3} \times {CH}_{i 4} \times {Q}_{cons} \times {G}_{i 1} \times H , \qquad ( 34 )$$

Pr_{grid}, Pr_{Xplace}, Gᵢ₁ and H are as mentioned above,
Q_{i1,pr} is the set defining the amount of energy able to be produced by the sub-agent S_ENTᵢ₁, and may be defined for example as follows: Q_{i1,pr}=[0, Q_{i1,max}], where Q_{i1,max} is the maximum amount of energy able to be produced during a predefined time interval, for example one hour, one day, etc.,
CHᵢ₃=[0, 100] defines the state of charge of the sub-agent S_ENTᵢ₃, in the current time interval IT_{c},
CHᵢ₄=[0, 100] defines the state of charge of the sub-agent S_ENTᵢ₄, in the current time interval IT_{c},
Q_{cons} is the set defining the possible values for the amount of energy consumed during a predefined time interval; Q_{cons} may be defined as an interval between a minimum consumption value and a maximum consumption value, such that Q_{cons}=[Q_{cons,min}, Q_{cons,max}], with continuous or discrete values between the two.

In S′2ᵢ₁, the sub-agent S_ENTᵢ₁ selects an action according to a compromise between using the learning result and exploring the action space, with a given probability (for example 0.9 for use and 0.1 for exploration).

In one preferred embodiment, the action is selected in an action space Aᵢ₁, which is for example as follows:

$${A}_{i 1} = {D}_{i 1} \times {Q}_{i 1 , ut} \times {I}_{i 1} , \qquad ( 35 )$$

Dᵢ₁ is the set of possible destinations for the energy produced by the sub-agent S_ENTᵢ₁ in the current time interval IT_{c}, and is expressed as follows: Dᵢ₁={1, 2, 3, 4, 5}, where 1 is representative of the energy marketplace, 2 is representative of the external energy supplier FE, 3 is representative of the storage sub-agent S_ENTᵢ₃, 4 is representative of the electric vehicle sub-agent S_ENTᵢ₄, 5 is representative of the energy-consuming devices,
Q_{i1,ut} is the set of amounts of energy produced by the sub-agent S_ENTᵢ₁ able to be used in the current time interval IT_{c}, and is defined for example as follows: Q_{i1,ut}=[0, Q_{i1,max}],
Iᵢ₁={0,1}, where 0 means that the sub-agent S_ENTᵢ₁ is not operating and 1 means that the sub-agent S_ENTᵢ₁ is operating or continues to operate if it was operating in the previous time interval.

In S′3ᵢ₁, the sub-agent S_ENTᵢ₁ receives a reward signal R_{i1,c}, which is for example as follows in one preferred embodiment:

$${R}_{i 1 , c} = {R}_{i 1 , ext , c} + {a}_{i 1} \cdot {R}_{i 1 , int , c} , \qquad ( 36 )$$

where
aᵢ₁ is a predefined weighting coefficient,
R_{i1,ext,c} defines an extrinsic reward from the environment in response to the action carried out by the sub-agent S_ENTᵢ₁. It may be defined in a current time interval as follows:

$${R}_{i 1 , ext , c} = {pr}_{c , Xplace} \times {q}_{i 1 , ut , c} if {d}_{i 1 , c} = 1 and \qquad ( 37 )$$

$${R}_{i 1 , ext , c} = {pr}_{c , grid} \times {q}_{i 1 , ut , c} if {d}_{i 1 , c} = 2 and \qquad ( 38 )$$

$${R}_{i 1 , ext , c} = 0 otherwise ,$$

where:
pr_{c,Xplace} ∈ Pr_{Xplace} and pr_{c,grid} ∈ Pr_{grid} are respectively the prices of energy in the marketplace and of the energy supplier in the current time interval IT_{c} under consideration and q_{i1,ut,c} ∈Q_{i1,ut} and d_{i1,c}∈Dᵢ₁ respectively denote the decision made at the end of this time interval under consideration regarding the amount of energy to be used and for which destination, for the following time interval,
R_{i1,int,c} defines an intrinsic reward that is received by the sub-agent S_ENTᵢ₁, which is consistent with the objectives transmitted by the agent ENTᵢ in S′4 (FIG. 11), this intrinsic reward being able to be defined in the current time interval as:
   R_{i1,int,c}=1 if i_{i1,c}=g_{i1,c} and R_{i1,int,c}=0 otherwise, where i_{i1,c}∈Iᵢ₁ and g_{i1,c}∈Gᵢ₁ respectively denote the action chosen by the sub-agent S_ENTᵢ₁ to either operate or not and the objective transmitted by the agent ENTᵢ in S′4 (FIG. 11), both for the following time interval IT_{c}.

Steps S′2ᵢ₁ to S′3ᵢ₁ are iterated in S′4ᵢ₁ up to a stop criterion so as to select, for each given state, an optimum action a^{opt}_{i1,c} from among Aᵢ₁, that is to say an optimum vector value for d_{i1,c}, q_{i1,ut,c} and i_{i1,c} for given values of pr_{c,grid}, pr_{c,Xplace}, q_{i1,pr,c}, ch_{i3,c}, ch_{i4,c}, q_{cons,c}, g_{i1,c} and h_{c}.

Such an optimum action a^{opt}_{i1,c} is recorded in S′5ᵢ₁ in a dedicated memory so as possibly to be selected in the following time interval in response to either use or exploration, or else to be used to implement real-time steps S′6ᵢ₁ to S′9ᵢ₁ of the same type as abovementioned steps S′8 to S′11.

A description will now be given, with reference to FIG. 13, of the sequence of an energy distribution method carried out by the storage sub-agent S_ENTᵢ₃, as illustrated in FIG. 10, in the context of the energy exchange method from FIG. 11.

Such an energy distribution method takes place as follows at the sub-agent S_ENTᵢ₃, in a current time interval IT_{c}.

In S′1ᵢ₃, a given state of the energy exchange system is initialized in the current time interval IT_{c}.

In one preferred embodiment, the state space Sis configured for the system is for example as follows:

$${S}_{i 3} = P {r}_{grid} \times {Pr}_{Xplace} \times {Carb}_{i 3} \times {CH}_{i 3} \times {CH}_{i 4} \times {Q}_{cons} \times {G}_{i 3} \times H , \qquad ( 39 )$$

Pr_{grid}, Pr_{Xplace}, Carbᵢ₃, Q_{cons}, Gᵢ₃ and H are as described above,
CHᵢ₃ defines the charge percentage of the sub-agent S_ENTᵢ₃, in the current time interval IT_{c}, and is expressed as follows: CHᵢ₃=[0,100].

In S′2ᵢ₃, the sub-agent S_ENTᵢ₃ selects an action according to a compromise between using the learning result and exploring the action space, with a given probability (for example 0.9 for use and 0.1 for exploration).

In one preferred embodiment, the action is selected in an action space Ais, which is for example as follows:

$${A}_{i 3} = {C}_{i 3} \times {D}_{i 3} \times {Q}_{i 3} , \qquad ( 40 )$$

Cᵢ₃ is a set defining the possible source of the energy recharged to the sub-agent S_ENTᵢ₃ in the current time interval IT_{c} and is expressed for example as follows: Cᵢ₃={0,1,2,3}, where 0 is representative of the absence of recharging, 1 is representative of the energy marketplace, 2 is representative of the external energy supplier FE, 3 is representative of the sub-agent S_ENTᵢ₁ in the case where it produces excess energy,
Dᵢ₃ is a set defining the possible destination for the energy discharged from the sub-agent S_ENTᵢ₃ in the current time interval IT_{c} and is expressed for example as follows: Dᵢ₃={0,1,2,3}, where 0 is representative of the absence of discharging, 1 is representative of the energy marketplace, 2 is representative of the external energy supplier FE, 3 is representative of the energy-consuming devices,
Qᵢ₃ is a set defining the recharging/discharging percentage of the sub-agent S_ENTᵢ₃ in the current time interval IT_{c}, and is expressed as follows:

$${Q}_{i 3} = [ 0 , 100 ] .$$

The action selected by the sub-agent S_ENTᵢ₃ thus consists in choosing to recharge or discharge, with what amount of energy (or otherwise what percentage of its capacity), and the source of this charging/destination for this discharging. If the sub-agent S_ENTᵢ₃ chooses to discharge by selling in the marketplace or to the supplier, this information is then transmitted to the agent ENTᵢ of the upper level L1 so as to be taken into account in the exchange strategy. This information bears the reference U_{i,c} in FIG. 10, such that, here, U_{i,c}=U_{i3,c}. As mentioned above, U_{i3,c} takes, as its value, the amount of energy to be sold in the marketplace or to the supplier and the carbon footprint Carbis, and 0 otherwise. It will then enter the state of the agent ENTᵢ. In FIG. 10, U_{i,c} is shown in dashed lines because it is not transmitted by all of the other sub-agents under consideration, in particular S_ENTᵢ₁, S_ENTᵢ₂₀, S_ENTᵢ₂₁.

In S′4ᵢ₃, the sub-agent S_ENTᵢ₃ receives a reward signal R_{i3,c}, which is for example as follows in one preferred embodiment:

$${R}_{i 3 , c} = {R}_{i 3 , ext , c} + {a}_{i 3} \cdot {R}_{i 3 , int , c} , \qquad ( 41 )$$

where
αᵢ₃ is a predefined weighting coefficient,
R_{i3,ext,c} defines an extrinsic reward from the environment in response to the action carried out by the sub-agent S_ENTᵢ₃. It may be defined in a current time interval as follows:

$${R}_{i 3 , ext , c} = {ε}_{i 3} \cdot {profit}_{i 3 , c} + ( 1 - {ε}_{i 3} ) \cdot {storage}_{i 3 , c} , where : \qquad ( 42 )$$

$${profit}_{i 3 , c} = {pr}_{c , Xplace} ( {q}_{i 3 , c} \cdot {Q}_{max} ) / 100 \qquad ( 43 )$$

$$if {d}_{i 3 , c} = 1 and {profit}_{i 3 , c} = {pr}_{c , grid} ( {q}_{i 3 , c} \cdot {Q}_{max} ) / 100 \qquad ( 44 )$$

$$if {d}_{i 3 , c} = 2 and {profit}_{i 3 , c} = - {pr}_{c , Xplace} ( {q}_{i 3 , c} \cdot {Q}_{max} ) / 100 \qquad ( 45 )$$

$$if {c}_{i 3 , c} = 1 and {profit}_{i 3 , c} = - {pr}_{c , grid} ( {q}_{i 3 , c} \cdot {Q}_{max} ) / 100 \qquad ( 46 )$$

$$if {c}_{i 3 , c} = 2 and {profit}_{i 3 , c} = 0 otherwise and$$

$${storage}_{i 3 , c} = {q}_{i 3 , c} - \vert {ch}_{i 3 , c} + {q}_{i 3 , c} - {Ch}_{i 3 , max} \vert \qquad ( 47 )$$

$$if {c}_{i 3 , c} \neq 0 ( charging ) and$$

$${storage}_{i 3 , c} = {q}_{i 3 , c} - \vert {ch}_{i 3 , c} + {q}_{i 3 , c} - {CH}_{i 3 , min} \vert \qquad ( 48 )$$

$$if {d}_{i 3 , c} \neq 0 ( dis charging ) ,$$

and |x| symbolizing the absolute value of a real number x,
where:
pr_{c,Xplace} and pr_{c,grid} are respectively the prices of the energy in the marketplace and of the energy supplier in the current time interval IT_{c} under consideration and q_{i3,c} ∈Qᵢ₃, d_{i3,c} ∈Dᵢ₃ and ch_{i3,c}∈CH₁₃ respectively denote the decision made at the end of this time interval under consideration concerning the amount of energy to be used and for which destination, for the following time interval and the state of charge of the sub-agent S_ENTᵢ₃ at the end of the current time interval,
storage_{i3,c} is a function that aims to maximize the amount to be charged and to minimize the distance between the current charge of the sub-agent S_ENTᵢ₃, incremented by the amount of energy to be charged, and the maximum charge value of the sub-agent S_ENTᵢ₃ in order not to move away from this maximum value in the case of recharging and in the case of discharging. storage_{i3,c} aims to maximize the amount of energy to be discharged and to minimize the distance between the current charge of the sub-agent S_ENTᵢ₃ decremented by the amount of energy to be discharged and the minimum charge of the sub-agent S_ENTᵢ₃, so as not to excessively exceed the minimum charge requested by the sub-agent S_ENTᵢ₃,
εᵢ₃ is a weighting coefficient,
R_{i3,int,c} defines an intrinsic reward that is received in keeping with the objectives transmitted by the agent ENTᵢ in S′4 (FIG. 11), this reward being able to be defined in a current time interval as follows:

$${R}_{i 3 , int , c} = 1 if {c}_{i 3 , c} = {d}_{i 3 , c} = {g}_{i 3 , c} = 0 ( do nothing ) or$$

$$if {d}_{i 3 , c} \neq 0 and {g}_{i 3 , c} = 1 or$$

$$if {c}_{i 3 , c} \neq 0 and {g}_{i 3 , c} = 2 and$$

$$if {r}_{i 3 , int , c} = 0 otherwise ,$$

where c_{i3,c} ∈Cᵢ₃ and g_{i3,c} ∈Gᵢ₃ respectively denote the action chosen by the sub-agent S_ENTᵢ₃ to choose the energy source for the recharging and the objective transmitted by the agent ENTᵢ in S′4 (FIG. 11), both at the end of the current time interval.

Steps S′2ᵢ₃ to S′3ᵢ₃ are iterated in S′4ᵢ₃ up to a stop criterion so as to select, for each given state, an optimum action a^{opt}_{i3,c} from among Aᵢ₃, that is to say an optimum vector value for c_{i3,c}, d_{i3,c}, q_{i3,c} for given values of pr_{c,grid}, pr_{c,Xplace}, Carb_{i3,c}, ch_{i3,c}, ch_{i4,c}, q_{cons,c}, g_{i3,c} and h_{c}.

Such an optimum action a^{opt}_{i3,c} is recorded in S′5ᵢ₃ in a dedicated memory so as possibly to be selected in the following time interval IT_{c+1} in response to either use or exploration, or else to be used to implement real-time steps S′6ᵢ₃ to S′9ᵢ₃ of the same type as abovementioned steps S′8 to S′11.

A description will now be given, with reference to FIG. 14, of the sequence of an energy distribution method carried out by the electric vehicle sub-agent S_ENTᵢ₄ as illustrated in FIG. 10, in the context of the energy exchange method from FIG. 11.

Such an energy distribution method takes place as follows at the sub-agent S_ENTᵢ₄, in a current time interval IT_{c}.

In S′1ᵢ₄, a given state of the energy exchange system is initialized in the current time interval IT_{c}.

In one preferred embodiment, the state space Sᵢ₄,c configured for the system is for example as follows:

$${S}_{i 4} = P {r}_{grid} \times {Pr}_{Xplace} \times {Carb}_{i 4} \times {CH}_{i 4} \times {Q}_{cons} \times {G}_{i 4} \times {E}_{i 4} \times H , \qquad ( 49 )$$

where:
Pr_{c,grid}, Pr_{c,Xplace}, Carbᵢ₄, Q_{cons}, Gᵢ₄ and H are as described above,
CHᵢ₄ defines the charge percentage of the sub-agent S_ENTᵢ₄, in the current time interval IT_{c}, and is expressed as follows: CHᵢ₄=[0,100],
Eᵢ₄ is the set of possible values for the amount of energy able to be consumed by the sub-agent S_ENTᵢ₄ during a given time interval, between 0 and a predefined maximum value.

In S′2ᵢ₄, the sub-agent S_ENTᵢ₄ selects an action according to a compromise between using the learning result and exploring the action space, with a given probability (for example 0.9 for use and 0.1 for exploration).

In one preferred embodiment, the action is selected in an action space Aᵢ₄, which is for example as follows:

$${A}_{i 4} = {C}_{i 4} \times {D}_{i 4} \times {Q}_{i 4} , \qquad ( 50 )$$

where:
Cᵢ₄ is a set defining the possible source of the energy used to recharge the sub-agent S_ENTᵢ₄ in the current time interval IT_{c} and is expressed for example as follows: Cᵢ₄={0,1,2,3,4}, where 0 is representative of the absence of recharging, 1 is representative of the energy marketplace, 2 is representative of the external energy supplier FE, 3 is representative of the sub-agent S_ENTᵢ₁ in the case where it produces excess energy, 4 is representative of the storage sub-agent S_ENTᵢ₃,
Dᵢ₄ is a set defining the possible destination for the energy discharged from the sub-agent S_ENTᵢ₄ in the current time interval IT_{c} and is expressed for example as follows: Dᵢ₄={0,1,2,3}, where 0 is representative of the absence of discharging, 1 is representative of the energy marketplace, 2 is representative of the external energy supplier FE, 3 is representative of the energy-consuming devices,
Qᵢ₄ is a set defining the recharging/discharging percentage of the sub-agent S_ENTᵢ₄ in the current time interval IT_{c}, and is expressed as follows:

$${Q}_{i 4} = [ 0 , 100 ] .$$

The action selected by the sub-agent S_ENTᵢ₄ thus consists in choosing to recharge or discharge, with what amount of energy (or otherwise what percentage of its capacity), and the source of this charging/destination for this discharging. If the sub-agent S_ENTᵢ₄ chooses to discharge by selling in the marketplace or to the supplier, this information is then transmitted to the agent ENTᵢ of the upper level L1 so as to be taken into account in the exchange strategy. This information bears the reference U_{i,c} in FIG. 10, such that, here, U_{i,c}=U_{i4,c}. As mentioned above, U_{i4,c} takes, as its value, the amount of energy to be sold in the marketplace or to the supplier and the carbon footprint Carbᵢ₄, and 0 otherwise. It will then enter the state of the agent ENTᵢ.

In S′4ᵢ₄, the sub-agent S_ENTᵢ₄ receives a reward signal R_{i4,c}, which is for example as follows in one preferred embodiment:

$${R}_{i 4 , c} = {R}_{i 4 , ext , c} + {a}_{i 4} \cdot {R}_{i 4 , i n t , c} , \qquad ( 51 )$$

where:
αᵢ₄ is a predefined weighting coefficient,
R_{i4,ext,c} defines an extrinsic reward from the environment in response to the action carried out by the sub-agent S_ENTᵢ₄. It may be defined in a current time interval as follows:

$${R}_{i 4 , ext , c} = {ε}_{1 , i 4} \cdot {profit}_{i 4 , c} + {ε}_{2 , i 4} \cdot {storage}_{i 4 , c} + {ε}_{3 , i 4} \cdot {discomfort}_{i 4 , c} , where : \qquad ( 52 )$$

$${profit}_{i 4 , c} = {pr}_{c , Xplace} \times ( {q}_{i 4 , c} \cdot {Q}_{max} ) / 100 \qquad ( 53 )$$

$$if {d}_{i 4 , c} = 1 and {profit}_{i 4 , c} = {pr}_{c , grid} \times ( {q}_{i 4 , c} \cdot {Q}_{max} ) / 100 \qquad ( 54 )$$

$$if {d}_{i 4 , c} = 2 and {profit}_{i 4 , c} = - {pr}_{c , Xplace} \times ( {q}_{i 4 , c} \cdot {Q}_{max} ) / 100 \qquad ( 55 )$$

$$if {c}_{i 4 , c} = 1 and {profit}_{i 4 , c} = - {pr}_{c , grid} \times ( {q}_{i 4 , c} \cdot {Q}_{max} ) / 100 \qquad ( 56 )$$

$$if {c}_{i 4 , c} = 2 and {profit}_{i 4 , c} = 0 otherwise and$$

$${storage}_{i 4 , c} = {q}_{i 4 , c} - \vert {ch}_{i 4 , c} + {q}_{i 4 , c} - {CH}_{i 4 , max} \vert \qquad ( 57 )$$

$$if {c}_{i 4 , c} \neq 0 ( recharging ) and$$

$${storage}_{i 4 , c} = {q}_{i 4 , c} - \vert {ch}_{i 4 , c} - {q}_{i 4 , c} - {CH}_{i 4 , min} \vert \qquad ( 58 )$$

$$if {d}_{i 4 , c} \neq 0 ( dis charging ) and$$

$${discomfort}_{i 4 , c} = {( {E}_{i 4 , max} - {e}_{i 4 , c} )}^{2} , \qquad ( 59 )$$

and ε_{1,i4}, ε_{2,i4}, ε_{3,i4} are predefined weighting coefficients,
and where:
pr_{c,Xplace} and pr_{c,grid} are respectively the prices of the energy in the marketplace and of the energy supplier in the current time interval IT_{c} under consideration and q_{i4,c} ∈Qᵢ₄, d_{i4,c} ∈Dᵢ₄ and ch_{i4,c} ∈CHᵢ₄ respectively denote the decision made at the end of this time interval under consideration concerning the amount of energy to be used and for which destination, for the following time interval and the state of charge of the sub-agent S_ENTᵢ₄ at the end of the current time interval,
E_{i4,max} and e_{i4,c} are respectively the maximum energy consumption during a predefined time interval and e_{i4,c} is the energy consumption of the sub-agent S_ENTᵢ₄ during the current time interval,
discomfort_{i4,c} is a factor determining the anxiety of the user of the sub-agent S_ENTᵢ₄ about not having enough energy to use it,
storage_{i4,c} is a function that aims to maximize the amount to be charged and to minimize the distance between the current charge of the sub-agent S_ENTᵢ₄, incremented by the amount of energy to be charged, and the maximum charge value of the sub-agent S_ENTᵢ₄ in order not to move away from this maximum value in the case of recharging and in the case of discharging. storage_{i4,c} aims to maximize the amount of energy to be discharged and to minimize the distance between the current charge of the sub-agent S_ENTᵢ₄ decremented by the amount of energy to be discharged and the minimum charge of the sub-agent S_ENTᵢ₄, so as not to excessively exceed the minimum charge requested by the sub-agent S_ENTᵢ₄,
R_{i4,int,c} defines an intrinsic reward that is received in keeping with the objectives transmitted by the agent ENTᵢ in S′4 (FIG. 11), this reward being able to be defined in a current time interval as follows:

$${R}_{i 4 , int , c} = 1 if {c}_{i 4 , c} = {d}_{i 4 , c} = {g}_{i 4 , c} = 0 ( do nothing ) or$$

$$if {d}_{i 4 , c} \neq 0 and {g}_{i 4 , c} = 1 or$$

$$if {c}_{i 4 , c} \neq 0 and {g}_{i 4 , c} = 2 and$$

$${r}_{i 4 , int , c} = 0 otherwise ,$$

where c_{i4,c} ∈ Cᵢ₄ and g_{i4,c} ∈Gᵢ₄ respectively denote the action chosen by the sub-agent S_ENTᵢ₄ to choose the energy source for the recharging and the objective transmitted by the agent ENTᵢ in S′4 (FIG. 11), both at the end of the current time interval.

Steps S′2ᵢ₄ to S′3ᵢ₄ are iterated in S′4ᵢ₄ up to a stop criterion so as to select, for each given state, an optimum action a^{opt}_{i4,c} from among Aᵢ₄, that is to say an optimum vector value for c_{i4,c}, d_{i4,c}, q_{i4,c} for given values of pr_{c,grid}, pr_{c,Xplace}, Carb_{i4,c}, ch_{i4,c}, q_{cons,c}, g_{i4,c}, e_{i4,c} and h_{c}.

Such an optimum action a^{opt}_{i4,c} is recorded in S′5ᵢ₄ in a dedicated memory so as possibly to be selected in the following time interval IT_{c+1} in response to either use or exploration, or else to be used to implement real-time steps S′6ᵢ₄ to S′9ᵢ₄ of the same type as abovementioned steps S′8 to S′11.

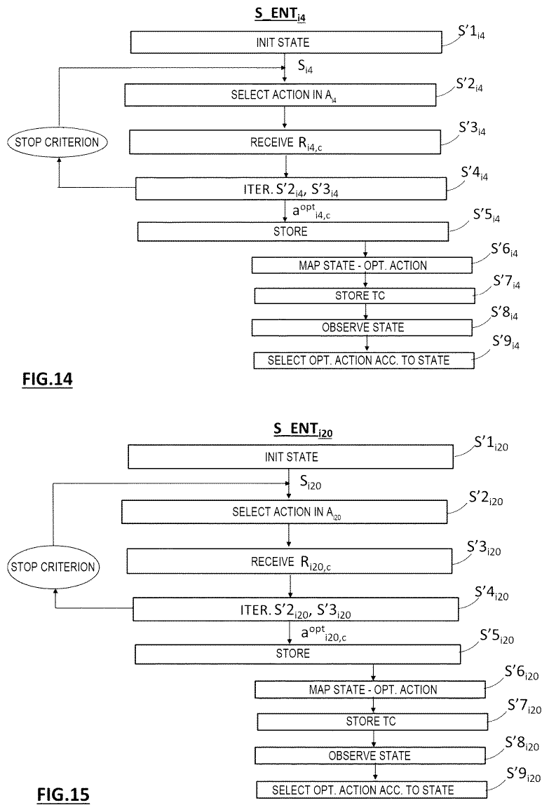

A description will now be given, with reference to FIG. 15, of the sequence of an optimum energy consumption method, as carried out by the sub-agent S_ENTᵢ₂₀ illustrated in FIG. 10, in the context of the energy exchange method from FIG. 11.

The sub-agent S_ENTᵢ₂₀ designates an energy-consuming device the use of which is time-shiftable.

Such an energy consumption method takes place as follows at the energy consumption sub-agent S_ENTᵢ₂₀, in a current time interval IT_{c}.

In S′1ᵢ₂₀, a given state of the energy exchange system is initialized in the current time interval IT_{c}.

In one preferred embodiment, the state space Sᵢ₂₀ configured for the system is for example as follows:

$${S}_{i 20} = {\overline{σ}}_{i 20} \times {G}_{i 20} \times H , \qquad ( 60 )$$

where Gᵢ₂₀ and H are as defined above and δᵢ₂₀={δ_{i20,k}}_{1≤k≤M}, where δ_{i20,k} represents a user dissatisfaction coefficient for a kth sub-agent S_ENTᵢ₂₀ and M represents the number of devices the use of which is time-shiftable.

In S′2ᵢ₂₀, the sub-agent S_ENTᵢ₂₀ selects an action a_{i20,c} according to a compromise between using the learning result and exploring the state space, with a given probability (for example 0.9 for use and 0.1 for exploration).

In one preferred embodiment, the action is selected in an action space Aᵢ₂₀, which is for example as follows:
Aᵢ₂₀={aₖ}_{1≤k≤M}, where aₖ ∈{0,1} where, for a kth device, 0 means that use thereof is shifted to another time interval and 1 means that it remains in operation.

In S′3ᵢ₂₀, the sub-agent S_ENTᵢ₂₀ receives a reward signal R_{i20,c}, which is for example as follows in one preferred embodiment:

$${R}_{i 20 , c} = {R}_{i 20 , ext , c} + {a}_{i 20} \cdot {R}_{i 20 , int , c} , \qquad ( 61 )$$

αᵢ₂₀ is a predefined weighting coefficient,
R_{i20,ext,c} defines an extrinsic reward from the environment in response to the action carried out by the sub-agent S_ENTᵢ₂₀. It may be defined in a current time interval as follows:

$${R}_{i 20 , ext , c} = - {ε}_{i 20} {\sum }_{k = 1}^{M} {P}_{i 20 , k} {a}_{i 20 , c} [ k ] - ( 1 - {ε}_{i 20} ) {\sum }_{k = 1}^{M} {δ}_{i 20 , k} ( 1 - {a}_{i 20 , c} [ k ] ) , \qquad ( 62 )$$

where:
P_{i20,k} is the operating power of the kth device,
α_{i20,c} is the action chosen at the end of the current interval IT_{c}; this is a vector representing the decisions made for the set of M devices: for example, if the sub-agent S_ENTᵢ₂₀ is representative of M=5 devices and the action is to shift the use of each of them, then α_{i20,c}=[0, 0, 0, 0, 0],
εᵢ₂₀ is a weighting coefficient,
R_{i20,int,c} represents an intrinsic reward that may be defined as follows:

$${R}_{i 20 , int , c} = 1 if {\sum }_{k = 1}^{M} {a}_{i 20 , c} [ k ] = M and {g}_{i 20 , c} = 0 or$$

$$if {\sum }_{k = 1}^{M} {a}_{i 20 , c} [ k ] < M and {g}_{i 20 , c} = 1 and$$

$${R}_{i 20 , int , c} = 0 otherwise ,$$

where g_{i20,c}∈Gᵢ₂₀ is the objective transmitted by the agent ENTᵢ at the end of the current time interval.

Steps S′2ᵢ₂₀ to S′3ᵢ₂₀ are iterated in S′4ᵢ₂₀ up to a stop criterion so as to select, for each given state, an optimum action a^{opt}_{i20,c} from among Aᵢ₂₀, that is to say an optimum vector value for a_{i20,c} of the M devices of the sub-agent S_ENTᵢ₂₀, for given values of δᵢ₂₀, g_{i20,c}, h_{c}.

Such an optimum action a^{opt}_{i20,c} is recorded in S′6ᵢ₂₀ in a dedicated memory so as possibly to be selected in the following time interval IT_{c+1} in response to either use or exploration, or else to be used to implement real-time steps S′6ᵢ₂₀ to S′9ᵢ₂₀ of the same type as abovementioned steps S′8 to S′11.

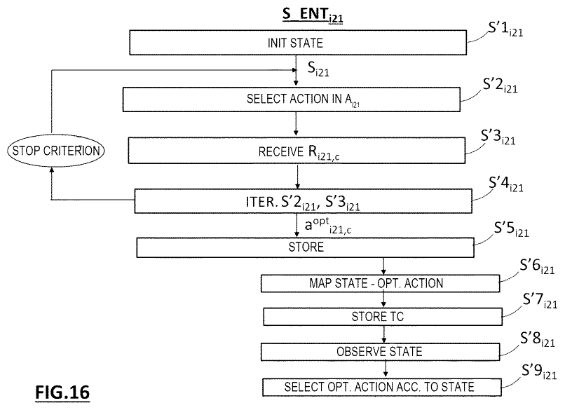

A description will now be given, with reference to FIG. 16, of the sequence of an optimum energy consumption method, as carried out by the sub-agent S_ENTᵢ₂₁ illustrated in FIG. 10, in the context of the energy exchange method from FIG. 11.

The sub-agent S_ENTᵢ₂₁ designates an energy-consuming device the operating power level of which may be made time-variable.

Such an energy consumption method takes place as follows at the energy consumption sub-agent S_ENTᵢ₂₁, in a current time interval IT_{c}.

In S′1ᵢ₂₁, a given state of the energy exchange system is initialized in the current time interval IT_{c}.

In one preferred embodiment, the state space Sᵢ₂₁ configured for the system is for example as follows:

$${S}_{i 21} = {\overline{σ}}_{i 21} \times {G}_{i 21} \times H , \qquad ( 63 )$$

where Gᵢ₂₁ and H are as defined above and δᵢ₂₁={δ_{i21,k}}_{1≤k≤k}, where δ_{i21,k} represents a user dissatisfaction coefficient for a power-shiftable kth sub-agent S_ENTᵢ₂₁ and N represents the number of devices the power of which is time-variable.

In S′2ᵢ₂₁, the sub-agent S_ENTᵢ₂₁ selects an action a_{i21,c} according to a compromise between using the learning result and exploring the action space, with a given probability (for example 0.9 for use and 0.1 for exploration).

In one preferred embodiment, the action is selected in an action space Aᵢ₂₁, which is for example as follows:
Aᵢ₂₁={Pₖ}_{1≤k≤N}, where Pₖ is a vector that designates the possible power values for the operation of a kth device of the sub-agent S_ENTᵢ₂₁.

In S′3ᵢ₂₁, the sub-agent S_ENTᵢ₂₁ receives a reward signal R_{i21,c}, which is for example as follows in one preferred embodiment:

$${R}_{i 21 , c} = {R}_{i 21 , ext , c} + {a}_{i 21} \cdot {R}_{i 21 , int , c} , \qquad ( 64 )$$

where
αᵢ₂₁ is a predefined weighting coefficient,
R_{i21,ext,c} defines an extrinsic reward from the environment in response to the action carried out by the sub-agent S_ENTᵢ₂₁. It may be defined in a current time interval as follows:

$${R}_{i 21 , ext , c} = - {ε}_{i 21} {\sum }_{k = 1}^{N} {a}_{i 21 , c} [ k ] - ( 1 - {ε}_{i 21} ) {\sum }_{k = 1}^{N} {δ}_{i 21 , k} ( {P}_{i 21 , max} [ k ] - {a}_{i 21 , c} [ k ] ) , \qquad ( 65 )$$

where:
α_{i21,c} is the action chosen at the end of the current interval IT_{c}, α_{i21,c} being a vector of decisions made for the set of N devices of the sub-agent S_ENTᵢ₂₁ regarding the power level to be used from among the levels available for each of them: for example, if the sub-agent S_ENTᵢ₂₁ is representative of 3 devices and the possible values for each of them are [P₁, P₂, P₃, P₄, P₅] and the action chosen at the end of the current time interval IT_{c} is to use the power level P₁ for the first two devices and the power level P₃ for the third device, then the action will be written as follows: α_{i21,c}=[P₁, P₁, P₃],
εᵢ₂₁ is a weighting coefficient,
P_{i21,max} is a vector representative of the maximum operating powers for all of the devices the power level of which is able to be adjusted,
R_{i21,int,c} represents an intrinsic reward that may be defined as follows:

$${R}_{i 21 , int , c} = 1 if {\sum }_{k = 1}^{N} {a}_{i 21 , c} [ k ] = {\sum }_{k = 1}^{N} {P}_{i 21 , max} [ k ] and {g}_{i 21 , c} = 0 or$$

$$if {\sum }_{k = 1}^{N} {a}_{i 21 , c} [ k ] < {\sum }_{k = 1}^{N} {P}_{i 21 , max} [ k ] and {g}_{i 21 , c} = 1 , and$$

$${R}_{i 21 , int , c} = 0 otherwise ,$$

where g_{i21,c} ∈Gᵢ₂₁ is the objective transmitted by the agent ENTᵢ at the end of the current time interval.

Steps S′2ᵢ₂₁ to S′3ᵢ₂₁ are iterated in S′4ᵢ₂₁ up to a stop criterion so as to select, for each given state, an optimum action a^{opt}_{i21,c} from among Aᵢ₂₁, that is to say an optimum vector value for a_{i21,c} of the N devices of the sub-agent S_ENTᵢ₂₁, for given values of δᵢ₂₁, g_{i21,c}, h_{c}.

Such an optimum action a^{opt}_{i21,c} is recorded in S′6ᵢ₂₁ in a dedicated memory so as possibly to be selected in the following time interval IT_{c+1} in response to either use or exploration, or else to be used to implement real-time steps S′6ᵢ₂₁ to S′9ᵢ₂₁ of the same type as abovementioned steps S′8 to S′11. In another embodiment, it is possible to consider an additional central entity located in the first hierarchical level L1 that is responsible for managing the correspondence between the bids and the requests made in the marketplace Xplace.

It should be noted that, in the abovementioned mathematical equations (1) to (65), all of the terms are normalized.

It goes without saying that the embodiments described above have been given purely by way of completely non-limiting indication, and that numerous modifications may be easily made by a person skilled in the art without departing from the scope of the invention.

1. A method comprising:
for exchanging energy within a set of at least two entities communicating with one another via a communication network and configured, respectively, in accordance with at least one energy use profile from among a first energy production profile, a second energy consumption profile and a third energy storage profile,
the exchanging implementing the following in a current time interval, at at least one of said entities:
receiving, via a reception module of said at least one of said entities, information relating to:
an amount of energy value that depends, in said interval, on an amount of energy produced and/or consumed and/or stored, respectively, by at least one energy production and/or consumption and/or storage sub-entity associated with said at least one entity,
value of a cost price of energy available from the other entity and/or from an energy supplier external to said set,
based on said values, selecting an action from among supplying energy to said other entity or to the external energy supplier, via an energy supply point of said at least one of said entities, requesting energy from said other entity or from the external energy supplier, via an energy delivery point of said at least one of said entities, said selection being implemented in accordance with an energy exchange performance criterion.

2. The energy exchange method as claimed in claim 1, wherein said energy exchange performance criterion that is used minimizes a cost of the energy requested by said at least one entity in said current time interval and maximizes a profit from supplying energy to the other entity or to the external energy supplier in said current time interval.

3. The energy exchange method as claimed in claim 1, wherein the received information furthermore comprises a carbon footprint value determined, in said current time interval, by said at least one energy production or storage sub-entity associated with said at least one entity, and transmitted by said at least one sub-entity to said at least one entity, and wherein said selection of an action is furthermore implemented based on said carbon footprint value in accordance with a criterion of minimizing the carbon footprint of the energy to be supplied to the other entity or to the external energy supplier.

4. The energy exchange method as claimed in claim 1, wherein the amount of energy to be consumed, in said current time interval, by at least one energy consumption sub-entity associated with said at least one entity is based on the energy consumption calculated at at least one energy-consuming device that is associated with said at least one energy consumption sub-entity, in accordance with the minimization of a criterion regarding dissatisfaction of a user of said at least one device, said criterion being related:
either to a shift in use of said at least one device to a time interval following the current time interval, if said at least one device has a time-shiftable use profile,
or to a decrease in a power level of said at least one device in the current time interval, if said at least one device has a power-shiftable use profile.

5. The energy exchange method as claimed in claim 1, wherein said at least one energy production sub-entity associated with said at least one entity implements the following in said current time interval:
receiving, via a reception module of said at least one energy production sub-entity, information relating to:
a value of the cost price of the energy available in said current time interval from the other entity and/or from an energy supplier external to said set,
the amount of energy stored, in said current time interval, by at least one energy storage sub-entity associated with said at least one entity, if said at least one storage sub-entity is present,
based on said value of the price and, where applicable, on said amount of energy stored, and in accordance with an energy production performance criterion:
selecting a destination for the energy produced by said at least one energy production sub-entity in the current time interval from among said other entity or the external energy supplier, said at least one energy storage sub-entity associated with said at least one entity, at least one energy-consuming device associated with said at least one energy consumption sub-entity,
calculating the amount of energy produced to be used according to the selected destination.

6. The energy exchange method as claimed in claim 1, wherein said at least one energy storage sub-entity associated with said at least one entity implements the following in said current time interval:
receiving, via a reception module of said at least one energy storage sub-entity, information relating to at least one value of the cost price of the energy available in said current time interval from an energy supplier external to said set,
based on said value of the price, on said amount of energy stored in said current time interval, by said at least one energy storage sub-entity, and according to a performance criterion regarding the use of the stored energy, selecting:
an action relating to not recharging or recharging said at least one storage sub-entity with energy,
an action relating to not discharging or discharging energy from said at least one storage sub-entity,
calculating the amount of energy required for the recharging, respectively discharging, if the action relating to the recharging, respectively discharging, is selected.

7. The energy exchange method as claimed in claim 6, wherein said performance criterion regarding the use of the stored energy maximizes duration of a life cycle of said at least one storage sub-entity.

8. The energy exchange method as claimed in claim 1, wherein steps implemented by said at least one entity, said energy production, energy consumption and energy storage sub-entities and said at least one energy-consuming device are executed using a learning algorithm.

9. The energy exchange method as claimed in claim 8, wherein the learning algorithm is a reinforcement learning algorithm, wherein:
said entities are agents, while said sub-entities and said at least one energy-consuming device are sub-agents associated with the agents,
the information received by the agents and the sub-agents is representative of an environment in which the energy exchange method is implemented,
said selected actions are decisions made by said agents.

10. The energy exchange method as claimed in claim 9, wherein, for at least one agent under consideration, said agent transmits at least one objective to at least one sub-agent associated therewith and in a given state, said objective having to be satisfied by said sub-agent and being integrated into said given state.

11. An entity configured to exchange energy with at least one other entity, said entity and said other entity communicating with one another via a communication network and belonging to a set of entities configured in accordance with at least one energy use profile from among a first energy production profile, a second energy consumption profile and a third energy storage profile, said entity comprising:
at least one processor; and
at least one non-transitory computer readable medium comprising instructions stored thereon which when executed by the at least one processor configure the entity to implement the following, in a current time interval:
receiving, via a reception module of said entity, information relating to:
an amount of energy value that depends, in said interval, on an amount of energy produced and/or consumed and/or stored, respectively, by at least one energy production and/or consumption and/or storage sub-entity associated with said at least one entity,
a value of a cost price of energy from the other entity and/or from an energy supplier external to said set,
based on said values, selecting an action from among supplying energy to said other entity or to the external energy supplier, via an energy supply point of said at least one of said entities, requesting energy from said other entity or from the external energy supplier, said selection being implemented in accordance with an energy exchange performance criterion.

12. (canceled)

13. A non-transitory computer-readable information medium comprising instructions of a computer program stored thereon which when executed by at least one processor of an entity configure the entity to exchange energy within at least one other entity, said entity and said at least one other entity communicating with one another via a communication network and being configured, respectively, in accordance with at least one energy use profile from among a first energy production profile, a second energy consumption profile and a third energy storage profile,
the exchanging implementing the following in a current time interval, at said entity:
receiving, via a reception module of said entity, information relating to:
an amount of energy value that depends, in said interval, on an amount of energy produced and/or consumed and/or stored, respectively, by at least one energy production and/or consumption and/or storage sub-entity associated with said at least one entity,
a value of a cost price of energy from the other entity and/or from an energy supplier external to said set,
based on said values, selecting an action from among supplying energy to said other entity or to the external energy supplier, via an energy supply point of said at least one of said entities, requesting energy from said other entity or from the external energy supplier, said selection being implemented in accordance with an energy exchange performance criterion.
